(19) United States
(12) Patent Application Publication
(10) Pub. No.: US 2013/0066861 A1
(43) Pub. Date: Mar. 14, 2013

(54) METHOD AND SYSTEM OF MANAGEMENT OF SEARCH RESULTS

(71) Applicant: Eugene M. O'Donnell, Fishers, IN (US)

(72) Inventor: Eugene M. O'Donnell, Fishers, IN (US)

(73) Assignee: CHACHA SEARCH, INC., Carmel, IN (US)

(21) Appl. No.: 13/612,377

(22) Filed: Sep. 12, 2012

Related U.S. Application Data
(60) Provisional application No. 61/534,204, filed on Sep. 13, 2011.

(51) Int. Cl. G06F 17/30

(52) U.S. Cl. 707/723; 707/E17.014

(57) ABSTRACT

A system and method for management of sponsored and organic search results is described. Sponsored results may be provided based on a ranking and a matching of a sponsored result and/or an organic result to a query. A sponsored or organic result may be provided algorithmically and/or using a human assistant.

### BACKGROUND

1. Field of the Invention

The present invention is related to use of sponsored search results and human assisted search.

2. Description of the Related Art

The practice of use of sponsored search results has been established beginning with sponsored telephone listings, and has been expanded by internet search engines. A search engine such as Google or the Bing® search engine may obtain sponsored search results from advertisers, which are presented in response to a user search query. A sponsored result is typically differentiated from an unsponsored or “organic” search result by an indication which may be more or less obvious to a user.

However, a sponsored search result may be less relevant to a user query than an organic search result based on a number of factors. A keyword based targeting, a location based targeting, etc. may cause a less than optimal sponsored result to be provided based on secondary considerations such as inventory control, bid prices, synonym usage, or other factors. In a system wherein a limited number of search results may be provided, presenting an unwanted search result is of limited value to an advertiser and to a user.

In a system employing human searchers to respond to queries, an advertiser may wish to answer a general question which is directed to a general category of products or services. However, if a search service provides a sponsored answer created by an advertiser, users may perceive that answers are being purchased, and might determine that answers are unreliable or biased. A perception of bias might damage use and credibility of a human assisted search service.

Because of these and other problems a method and system of using sponsored answers would be greatly appreciated.

### SUMMARY

A system is provided which includes a query processing server which receives queries, determines an appropriate response, and distributes the query, a guide system operated by a human searcher receiving a request and providing a search result, a user system submitting a request, an advertiser system providing sponsored answers and bid prices, and a database storing information associated with queries and responses.

When a query is received by the search system, the query may be analyzed to determine if an automated response to the query is suitable. When a query matches a stored or programmatically generated query, a stored response and information associated with the stored response may be obtained. A stored response may include a sponsored answer provided by an advertiser or a predetermined resource. A stored response may include a search result obtained by a human searcher responsive to a previous query. A human searcher may be an unsponsored searcher and/or may be a searcher sponsored by an advertiser or supplier to respond to a query. A sponsored answer may be provided to a user prior to an unsponsored or organic search result.

An answer may be obtained from a highest ranking resource. If an unsponsored answer is not found, a user query may be directed to an unsponsored human searcher or guide who obtains a search result responsive to the query. A sponsored human searcher, who may be directly controlled by a sponsor, may obtain a search result when a stored sponsored result is not available. An organic answer and a sponsored answer may be compared, which may affect whether a sponsored answer is delivered. If a sponsored answer differs from an organic answer the sponsored answer may be provided responsive to a request.

An advertiser or sponsor may bid on a query, a programmatically determined query, a vocabulary associated with a topic, etc. An advertiser may target a sponsored answer based on properties such as location, demographic, personality, affiliation and other parameters associated with a recipient of an answer. A sponsored answer may be associated with multiple queries. Multiple queries may be associated with a sponsored answer. A sponsor may search a database of stored queries.

Additional aspects and/or advantages will be set forth in part in the description which follows and, in part, will be apparent from the description or may be learned by practice of the invention. These together with other aspects and advantages, which will be subsequently apparent, reside in the details of construction and operation as more fully hereinafter described, reference being had to the accompanying drawings forming a part hereof, wherein like numerals refer to like parts throughout.

### BRIEF DESCRIPTION OF THE DRAWINGS

Aspects and advantages of the disclosure will become apparent and more readily appreciated from the following description of the embodiments, taken in conjunction with the accompanying drawings, of which:

FIG. 1 is a block diagram of an exemplary system embodiment.

FIG. 2 illustrates a database for requests.

FIG. 3 illustrates a database for users.

FIG. 4 illustrates a database for guides.

FIG. 5 illustrates a database for resources.

FIG. 6 illustrates a database for sponsored answers

FIG. 7 illustrates a database for sponsors.

FIG. 8 is a flowchart of providing an answer.

FIG. 9 is a flowchart of processing a query.

FIG. 10 is a flowchart of tracking a sponsored answer.

FIG. 11 is a Graphical User Interface (GUI) for processing a request by an expediter.

FIG. 12 is a GUI for processing a request by a searcher.

FIG. 13 is a GUI for processing a request by a searcher associated with a sponsored answer.

FIG. 14 is a GUI for processing a request by a searcher associated with an organic answer.

FIG. 15 is a GUI for selection and editing of queries and sponsored answers.

FIG. 16 is a GUI for selection and editing of queries associated with sponsored answers.

FIG. 17 is a GUI for registration of a sponsor.

FIG. 18 is an exemplary sequence of messages.

### DETAILED DESCRIPTION OF THE PREFERRED EMBODIMENTS

Reference will now be made in detail to the present embodiments discussed herein. Examples are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate. As used herein, words importing the singular shall include the plural and vice versa unless specifically counter indicated.

A system is provided which includes a user system for submitting a query and receiving a response, a search server receiving the query, a database storing information of queries, search results, searchers, users, resources and other information, a guide system receiving a query and providing a search result, and a sponsor system providing sponsored answers.

A system is implemented to allow a user to submit a query and receive a response. A response may include any type of media such as text, URL's, audio, video, etc. A response may be produced automatically and/or using the assistance of a person. A query may be submitted using any suitable device and/or communication service such as SMS, MMS, voice, Instant Messaging, VoIP, internet packet communication, email, etc.

Processing of a query may be divided into various layers. A first layer may consist of automated processing of a query. Automated processing of a query may include comparison of a query to a database, analysis of a query using semantic techniques, pattern matching, etc. which may be used to determine a response to a query. Results of automated processing such as categorization, spelling correction, named entity extraction, location association, etc. may be stored for later use.

A second layer of processing of a query may include a human assistant who analyzes a query or “expediter”. An expediter uses the human ability to recognize context in order to determine a response to a query. An expediter may be provided with relevant context of a query, and offered various options for responding to a query. In its simplest form, an expediter might be presented with a question and two or more options for responding to the question. An expediter may be provided with a rich toolset which provides a greater depth and breadth of responses which may be interactive. In at least one embodiment, an expediter may be provided with responses from a predetermined set of resources.

A third layer of processing of a query may include a human assistant who responds to a query or “searcher”. A searcher may receive an interpreted query, information of a source of a query, and be provided with resources for performing a search responsive to a query. A searcher may formulate a response based on an interpreted query, and submit the response for delivery to a user responsive to the query and/or an interpreted query. In at least one embodiment, a searcher may receive information of resources which may be used to provide a response, and/or resources which are excluded from providing a response.

A resource may be characterized according to various parameters. A resource may be evaluated based on a number of responses obtained or acquired from and/or using the resource. A resource may be evaluated based on a number of times that a response obtained from the resource is reused. A resource may be evaluated based on an affiliate relationship between a provider of the resource and a provider of a search service.

As used herein, a “request” means a request for information, products, and/or services. A request or search request or query may include various types of media, and may be provided by any user system which may establish communication with a server and/or other devices associated with a search service. A request may be referred to as a “search request”, “search query”, “question” or “query”.

A “user” is a person who submits a request and may receive any type of information responsive to a request. A user may be any person or entity. A “guide” is a person who assists in processing a request. A guide or human assistant may be referred to as a “provider”, “searcher”, “human searcher”, “expediter”, “transcriber”, “specialist” or “generalist”. Guides may be assigned various roles. A guide who transcribes a user request from one form to another may be referred to as a transcriber. A guide who reviews a query, determines a most likely response, and may modify a query may be referred to as an expediter or “ambassador”. A guide who performs a search for queries associated with a category may be referred to as a specialist. A guide who performs a search for queries regardless of category may be referred to as a generalist. Any guide may perform any role.

An “advertiser” is any person and/or entity which may provide promotional information or “advertisements” to be delivered to a user. An advertisement may take various forms and/or may include media of any sort which can be delivered to a user device. A “result”, “response”, “answer”, or “search result” is any information which has been determined to be a response to a request. A result may include an advertisement. A result may be any information which is provided as a response to a request. A “resource” or “search resource” may be any source of information which may provide a search result and/or other information. A resource may include a search engine, a web server, a software application, an API, printed media, an RSS feed, streaming media, a web page, a database, etc. A “profile” may be any information associated with a person such as demographic data, geographic data, personality data, affiliations, etc. A result may be an “organic” result which is a result produced by a search which has no intentional bias applied. A result may be a “sponsored” result which is provided and/or approved by a provider with a commercial interest in the response and/or providing the response to a user based on a request associated with a sponsored answer or sponsored result.

A sponsored answer may be created in various ways. A sponsored answer may be created by an advertiser or sponsor based on historical queries received by a search service. For example, an advertiser might search a database for queries including a generic noun which describes a branded product and/or service associated with the advertiser. If an advertiser locates a query of group of queries indicating that generic reference, the advertiser may determine a sponsored answer which is to be associated with a query. An advertiser may be presented with a number of suggested alternate forms of a selected query which may also be associated with a sponsored answer. An advertiser may be presented with usage statistics of a generic and/or a query which may influence a decision by the advertiser. An advertiser may provide targeting information associated with a sponsored answer. Targeting information may include geographic, demographic, personality, affiliation, etc. information which may prioritize and/or limit delivery of a sponsored answer. An advertiser may specify parameters such as pricing, delivery intervals, maximum usages, etc. of a sponsored answer.

A sponsored answer may be created based on a search by a human searcher and/or an automated search. A sponsored answer may be created by a human searcher selected by an advertiser based on a search by the human searcher associated with a generic description such as a keyword. For example, an advertiser may determine that queries associated with the keyword ‘sedan’ are to be directed to a human searcher selected by the advertiser to perform a search regarding that keyword. A search resource such as a database, web page, software application, etc. selected by an advertiser or sponsor may be used to procure a sponsored answer by an automated and/or human assisted search. For example, if a query is associated with a category, a search may be performed using a search resource selected for the category by an advertiser to produce a sponsored answer for the query. If a sponsored answer is associated with a search query based on a search, alternate queries may be generated automatically. An advertiser and/or a human assistant may approve and/or reject the association of an alternate query with a sponsored answer.

A human assistant such as an expediter may select a search result associated with a previous query and/or an automated resource. A search result selected by a human assistant may be indicated as a sponsored result and/or an organic result. A human assistant may be presented with sponsored results, organic results, and/or a mixture of organic and sponsored results. An expediter may be associated with a sponsor, and may be presented with sponsored results associated with the sponsor.

The terms voice and speech are used interchangeably herein. A user, a guide and/or a search system may establish a communication session using a voice service, a messaging service such as Short Messaging Service (SMS), Enhanced Messaging Service (EMS), Multi-media Messaging Service (MMS), Instant Messaging (IM), email, an internet portal or web page, an application, regular mail and/or any other suitable type of communication. A connection or communication session may be established using any device which is capable of utilizing a communication service. For example, a wireless device such as a cell phone, PDA, smart phone, tablet, etc., might be used to establish a communication session using voice, SMS, IM, email and/or internet protocols. A desktop, laptop or server system might be used to establish a communication session using IM, email, SMS, MMS, etc. A landline phone, a specialized communication terminal, and/or any other communication device might be used to establish a communication session.

Communication between a user, a guide and/or a search system may include conversion of text to speech and speech to text. Any type of media which can be sent and/or received using a communication system may be part of a communication session. A communication session may be conducted using any or all communication services associated with a user, a guide, and/or a search system. Any communication session may include communication via multiple services and/or devices. For example, a request may be submitted as a voice query, which might indicate an image located on a resource accessible to a user. A voice query might be converted to a text message, the image might be processed in order to associate a tag and/or other images with the image, and a response might be provided as a spoken reply to a mobile phone associated with a user, and a video presentation which is accessible via a high-speed connection that might be delivered to a browser functionality of a different user device.

An advertisement may be transmitted, including during any or all communication sessions. A guide, a user, a search result, a resource, a responder, an advertiser and/or a request may be rated. Rating information may be obtained from a user, a guide, an advertiser and/or an administrator of a search system. Rating information may be used to select a user, a guide, a request, a result, a responder, an advertiser, and/or any item based on information associated with an item indicated in a database. A search service may be compensated by advertising revenue. Advertising and/or content may be delivered to a user and/or a guide using any communication service associated with a user and/or a guide. An advertiser or sponsor may request and obtain information regarding usage, users, demographics, affiliations, etc. associated with queries, keywords, categories, resources etc. and may submit sponsored answers and associate sponsored answers with queries based on information provided.

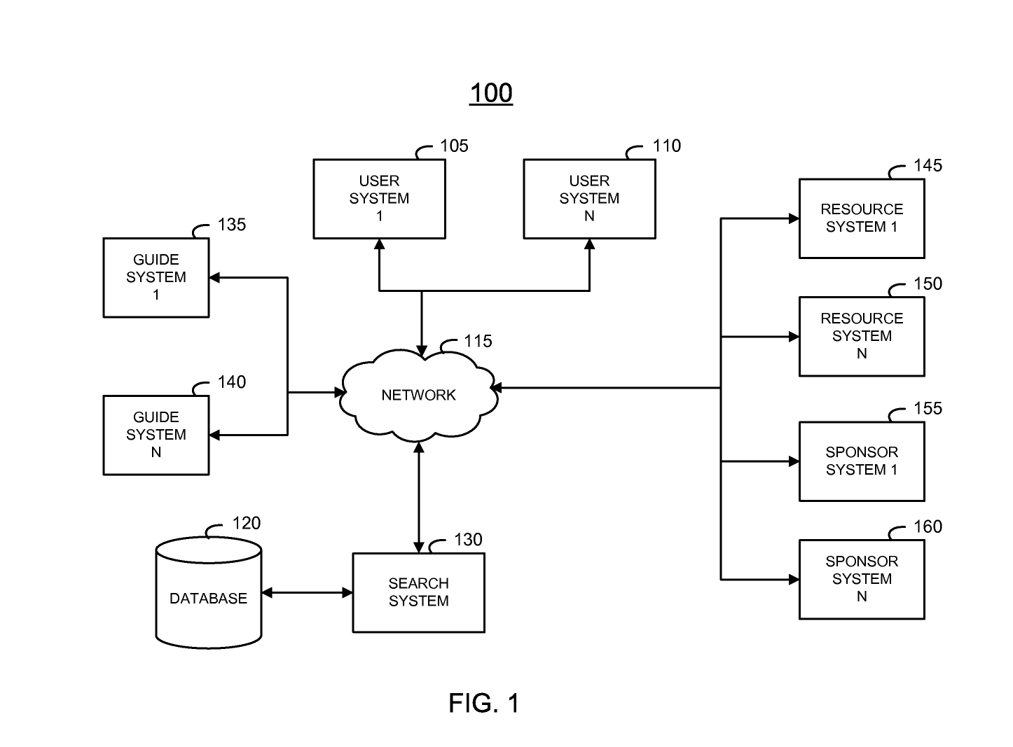

As illustrated in FIG. 1, system 100 includes user systems 105, 110, a network 115 such as the Internet, a search system 130, a database 120, which may comprise various records, guide systems 135, 140, resource systems 145, 150, and sponsor systems 155, 160.

While only a few systems associated with a user, a resource, a sponsor and a guide are depicted in FIG. 1 it is within the scope of the disclosure for multiple systems for a user, resource, sponsor and guide to be utilized. In particular it is envisioned that many user, resource, sponsor and guide systems may be implemented. The search system 130 may be composed of many components as described further herein.

Any user system (e.g. the user system 105) can be used, to submit a request to the search system 130 and/or receive a result and/or other information. Any user system may receive a response, and/or may provide compensation to the search system 130.

The network 115 may be a global public network of networks (i.e., the Internet) and/or may consist in whole or in part of one or more private networks and communicatively couples the user systems 105, 110, the guide systems 135, 140, the resource systems 145, 150 and the sponsor systems 155, 160 with the other components of the system such as the search system 130, and the database 120. The network 115 may include one or more wireless networks which may enable wireless communication between the various elements of the system 100. For example, the search system 130 may receive messages which may be routed via a wireless network controlled by a wireless service to the user systems 105, 110. A wireless service may receive messages from the guide systems 135, 140 via a wireless network which is a part of the network 115, and provide the messages to the search system 130 via an internet connection which is part of the network 115. Similarly a voice communication via wired and/or wireless communication might be established between any elements of the system 100.

The search system 130 allows interaction to occur among the user systems 105, 110, the guide systems 135, 140, the resource systems 145, 150 and the sponsor systems 155, 160. For example, a request can be transmitted from the user system 105 to the search system 130, which may provide information obtained from the database 120, which may include an advertisement provided by the sponsor system 155 to the user system 105. Similarly, a search result from a searcher operating the guide system 135 and/or the resource system 145 might be routed to the search system 130, which might process the search result, formulate a response and provide a message to the user system 105. Any type of communication between users, resources, sponsors and/or guides may be mediated and/or facilitated by the search system 130, and/or other elements of the system 100.

The search system 130 is communicatively coupled with the database 120. As will be described herein in further detail below, the database 120 includes data that is processed in association with operation of the embodiments. Although FIG. 1 illustrates the database 120 as a separate component of the system, the database 120 may be integrated with the search system 130. Further, the records maintained in the database 120 may be stored in any typical manner, including in a Network Attached Storage (NAS), a Storage Area Network (SAN), RAID, etc., using any typical or proprietary database software such as DB2®, Informix®, Microsoft® SQLServer™, MySQL®, Oracle®, etc., and may also be a distributed database on more than one server. Elements of the database 120 may reside in any suitable elements of the system 100. Any or all elements of the system 100 may include any or the entirety of the database 120.

The user systems 105, 110, the guide systems 135, 140, the resource systems 145, 150, the sponsor systems 155, 160 and the search system 130 may include equipment, software, systems and personnel required to send and/or receive messages between a user system 105, 110, the guide systems 135, 140, the resource systems 145, 150 the sponsor systems 155, 160 and/or the search system 130 using the network 115. The database 120 includes information which may allow the search system 130 to establish communication between any or all of the elements of the system 100.

A user system, a guide system, a resource system, a resource system and/or a search system may be a desktop, portable, or tablet PC or Mac®, a mobile phone, a smart phone, a PDA, a server system, a landline phone, a specialized communication terminal, a terminal connected to a mainframe, or any other communication hardware and/or system. The search system 130 may include one or more servers, computers, etc. For example, servers such as the PowerEdge® 2900 by Dell, or the BladeCenterJS22 by IBM, or equivalent systems might be used to implement elements of the search system 130. The search system 130 may utilize an operating system (OS) such as Microsoft Windows XP, or Linux, etc. Voice routing and packet switching may be accomplished using well established technologies such as those provided by Cisco, or other networking companies. After being presented with the disclosure herein, one of ordinary skill in the relevant art will immediately realize that any viable computer systems or communication devices known in the art may be used as user systems, guide systems, sponsor systems, resource systems, and/or to implement the search system 130.

A user may be identified by the search system 130. When a user system, such as the user system 105, establishes a communication session with the search system 130, an identifier of a user system is determined. An identifier of a user system may be associated with other information regarding a user. A user system may be identified using an email address, a telephone number, an IM credential, a username, and/or any other identifier which may be used to associate information with a user. Multiple identifiers of a user may be associated with each other. Using information of communication services associated with a user, a communication session may be established between a user system such as the user system 105 and a resource system, a guide system, a sponsor system and/or the search system 130. Information such as a keyword, a category, a user profile, a request, a result, etc., may be associated with a user. A user may be required to provide profile information to the search system 130. A user may elect to receive requests from the search system 130. Parameters and/or attributes may be associated with a resource as will be further described herein below. Information of a user may be stored in the database 120.

A guide may be required to register with the search system 130. As part of a registration process, at least one communication method is associated with a guide. In at least one embodiment, a guide may register with the search system 130 and establish a username and password which are associated with the guide. A guide may login to the search system 130 using a web browser functionality of the guide system 135 in order to communicate with the search system 130. Multiple communication services may be associated with a guide and may allow a communication session to be established between a guide system such as the guide system 135 and a user system, a resource system, a sponsor system, and/or the search system 130. Multiple identifiers of a guide may be associated with each other. Information such as IM credentials, an email address, a phone number, a URL, a username, etc., of a guide may be identified which may allow the search system 130 to establish a communication session between a guide system and a user system, a resource system, a sponsor system and/or the search system 130.

When a guide registers with the search system 130 the guide may be associated with one or more keywords, categories, profiles, and/or other information. Information associated with a guide may be stored in the database 120 and may be used for various purposes. Information associated with a guide may be used to rank requests, resources, results, advertisements, sponsors and/or other information which may be presented to the guide. In at least one embodiment, payment information is associated with a guide. In at least one embodiment, a guide may be required to undergo testing to determine whether a guide is able to perform any tasks which may be required by the search system 130. For example, a guide may be assigned to a role such as translator, transcriber, expediter, generalist, specialist, auditor, etc. A guide may be registered by a sponsor. A sponsor may provide compensation to a sponsored guide.

A sponsor may be required to register with the search system 130. As part of a registration process, at least one communication method is associated with a sponsor. In at least one embodiment, a sponsor may register with the search system 130 and establish a username and password which are associated with the sponsor. A sponsor may login to the search system 130 using a web browser functionality of the sponsor system 155 in order to communicate with the search system 130. Multiple communication services may be associated with a sponsor and may allow a communication session to be established between a sponsor system such as the sponsor system 155 and a user system, a resource system, a guide system, and/or the search system 130. Multiple identifiers of a sponsor may be associated with each other. Information such as IM credentials, an email address, a phone number, a URL, a username, etc., of a sponsor may be identified which may allow the search system 130 to establish a communication session between a sponsor system and a user system, a guide system, a resource system and/or the search system 130.

When a sponsor registers with the search system 130 the sponsor may be associated with one or more keywords, categories, profiles, and/or other information. Information associated with a sponsor may be stored in the database 120 and may be used for various purposes. Information associated with a sponsor may be used to rank requests, resources, results, advertisements, guides and/or other information which may be presented to the sponsor. In at least one embodiment, payment information is associated with a sponsor. A sponsor may provide payment information which may be used to compensate the search system 130 for advertisements and/or sponsored answers provided to a user. A sponsor may designate a guide associated with a sponsor, and may provide registration information associated with the sponsored guide. A sponsor may provide information associated with a resource. A sponsor may designate conditions for accessing a resource provided by the sponsor.

Records may be maintained in the database 120 which may be used to record the status of various items. Such records may be used to aid the processing of requests and production of responses or answers. For example, a user may submit a request, which may describe a desired response, and provide access to information and/or materials needed to produce the response. Information indicated in a record may be combined with information in other records, and may be used to produce tables, as further described herein.

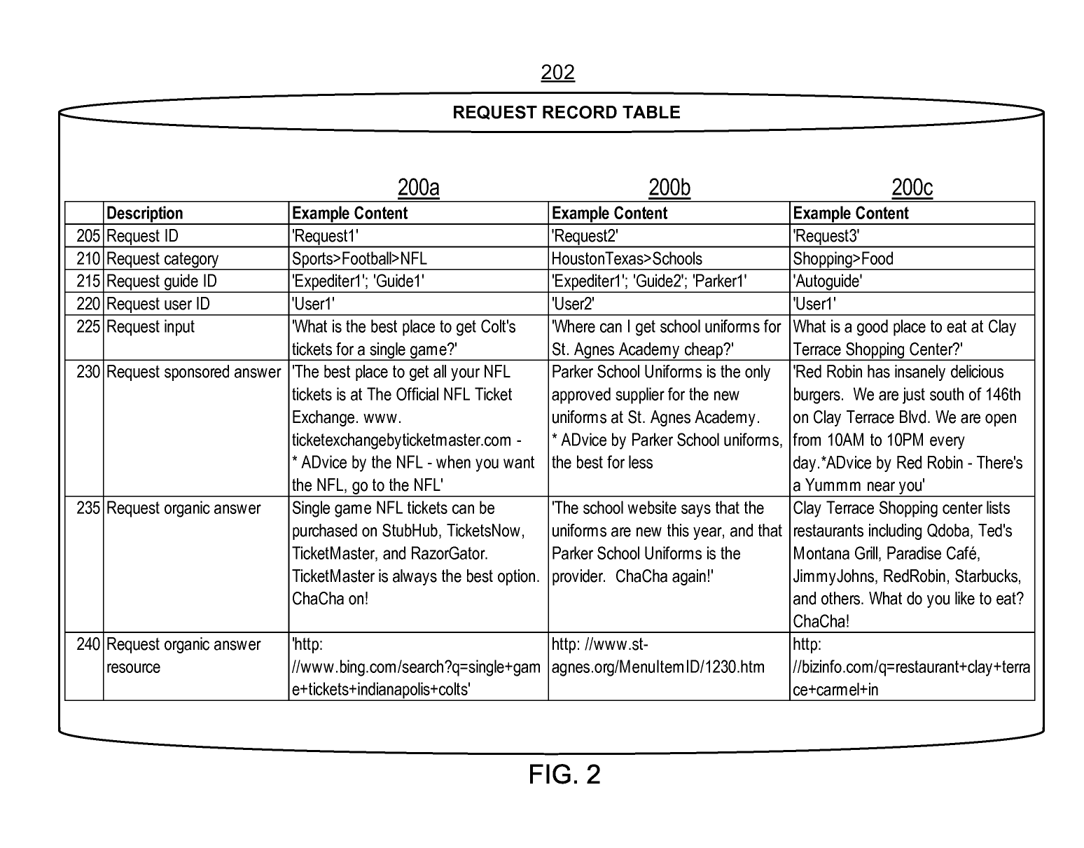

As illustrated in FIG. 2 an exemplary request record table 202 which may comprise a number of request records of which one or more may be associated with or resident in the database 120 (FIG. 1) is provided. The request record table 202 may include information of requests which may be processed. Request records may include a request ID field 205, a request category field 210, a request guide ID field 215, a request user ID field 220, a request input field 225, a request sponsored answer field 230, a request organic answer field 235, and a request organic answer resource field 240.

The request ID field 205 includes an identifier of a request which is preferably unique and is preferably used consistently. A request ID serves to distinguish a request record associated with a request from a request record associated with other requests. Any number of characters, numbers, and/or other indicators may be used to indicate a request ID. In at least one embodiment, a request ID associated with a request is included in the request ID field 205. In at least one embodiment, a random number is indicated in the request ID field 205. Using the example in FIG. 2, ‘Request1’ is the request ID associated with the request record 200a.

The request category field 210 may include information of a category associated with a request. Information indicated in the request category field 210 may be used to select an item associated with a request. For example, a category associated with a request may be used to rank guides who may be associated with the type of request. Likewise, a category associated with a request may be used to rank requests which may be presented to a guide. A category associated with a request may be determined based on factors such as keywords of a query, a profile of a user, a selection of a guide, a user history, etc. A category associated with a system taxonomy may be indicated in the request category field 210. A category may be associated with a request automatically and/or using the assistance of a person. Using the example in FIG. 2, ‘Request2’ may be categorized as ‘HoustonTexas>Schools’ as indicated in the request record 200b. This may indicate that a person or item associated with the category ‘HoustonTexas>Schools’ may have a higher ranking for responding to ‘Request2’. A category of a request may be associated with a user submitting the request. Content of a request such as a keyword, named entity, etc. may be used to assign a category or type to a request.

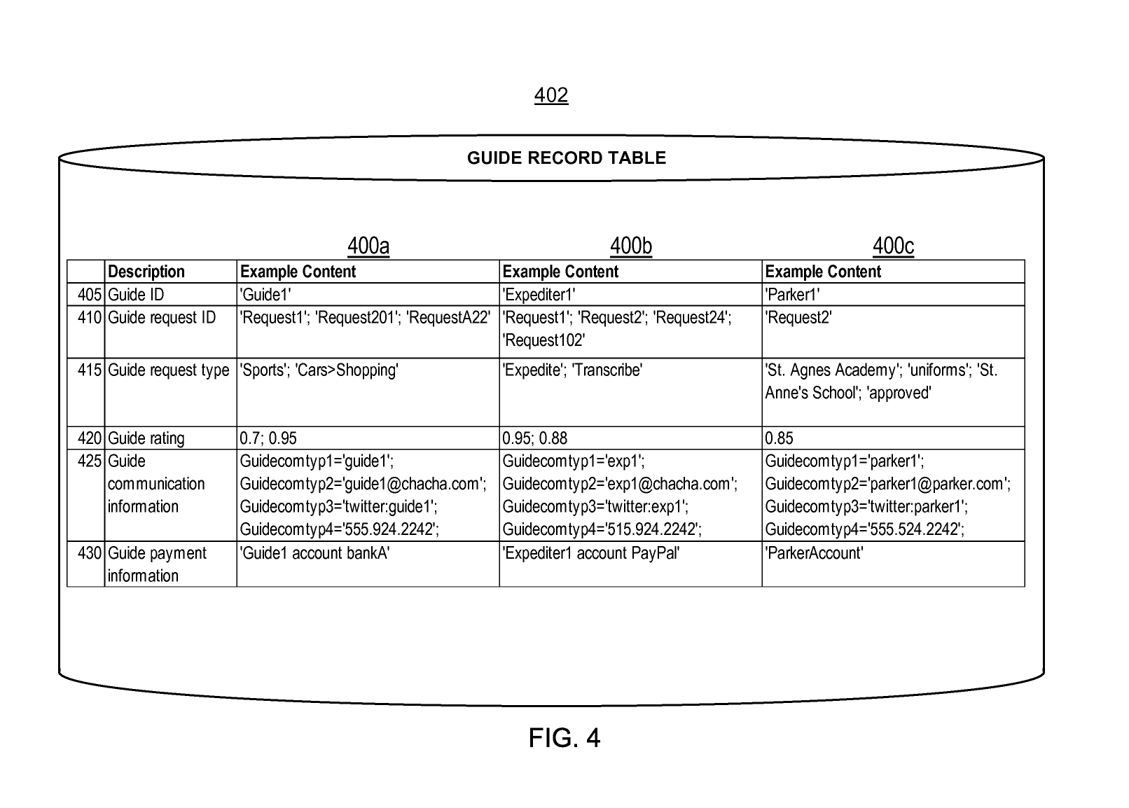

The request guide ID field 215 may include information of a number of guides associated with a request. Content of the request guide ID field 215 may be used to obtain information of a guide using a record such as the guide record 400b (FIG. 4). If a person is selected for a request, elects to receive a request, provides a response to a request, reviews a result of a request and/or completes a request, an identifier of the person may be indicated in the request guide ID field 215. Using the example in FIG. 2, ‘Expediter1’ and ‘Guide1’ are associated with ‘Request1’. This may for example indicate that ‘Request1’ has been processed by ‘Expediter1’ and completed by ‘Guide1’.

The request user ID field 220 may include information of a number of users associated with a request. Content of the request user ID field 220 may be used to obtain information of a user associated with a request. For example, if a request is submitted by a user, an identifier of the user may be indicated in the request user ID field 220. A request may not be associated with a user request. For example, the search system 130 (FIG. 1) may provide requests to persons which are not directly related to a user request. The search system 130 may provide a request to a searcher based on a selection of the request by a sponsor. Using the example in FIG. 2, ‘User1’ is associated with ‘Request1’ and ‘User2’ is associated with ‘Request2’. This may indicate that ‘Request1’ was submitted by ‘User1’ while ‘Request2’ was submitted by ‘User2’.

The request input field 225 may include information of a request. Content of the request input field 225 may be provided to a person who accepts a request. Content of the request input field 225 may include any type of information. For example, a pointer to audio, video, text, and/or other media may be indicated in the request input field 225. As illustrated in FIG. 2, the query ‘What is a good place to eat at Clay Terrace Shopping Center?’ is the request input associated with ‘Request3’, as indicated in the request record 200c. In at least one embodiment, the request input field 225 may indicate an original user request, a categorization, and a rewritten user request.

The request sponsored answer field 230 may include information of a response associated with a request. Content of the request sponsored answer field 230 may be provided to a responsive to a request. Content of the request sponsored answer field 230 may be stored in the database 120 (FIG. 1). Content of the request sponsored answer field 230 may be reviewed and/or rated by a user, a guide, an expert, and/or an administrator. As illustrated in FIG. 2, the response ‘Red Robin has insanely delicious burgers. We are just south of 146th on Clay Terrace Blvd. We are open from 10 AM to 10 PM every day. *ADvice by Red Robin—There's a Yummm near you’ is associated with ‘Request3’ as illustrated in the request record 200c. While a text response to a query is used for the purposes of illustration, any type of media such as images, audio, video, etc. may be indicated in the request sponsored answer field 230. In at least one embodiment, a text response and a URL associated with a source of the text response may be indicated in the request sponsored answer field 230.

The request organic answer field 235 may include information of an organic search result associated with a request. Content of the request organic answer field 235 may be used to provide an organic search result. For example, a guide may cut a snippet of text from a web page in order to create a response to a request. An organic answer may include various types of media such as text, images, audio, HTML and/or other mark-up language or code, etc. Content of the request organic answer field 235 may be produced automatically and/or using the assistance of a person. Using the example in FIG. 2, the answer ‘Clay Terrace Shopping center lists restaurants including Qdoba, Ted's Montana Grill, Paradise Café, JimmyJohns, RedRobin, Starbucks, and others. What do you like to eat? ChaCha!’ is associated with the request record 200c, which may indicate that ‘Request3’ was answered using a stored response, as indicated by the presence of the ‘Autoguide’ indicator in t request guide ID field 215 of the request record 200c.

The request organic answer resource field 240 may include information of a resource associated with a request. Content of the request organic answer resource field 240 may be used for various purposes. For example, a URL indicated in the request organic answer resource field 240 may be used to determine whether an organic answer is produced from a different resource than a sponsored answer. A URL associated with a response may be used to determine whether a response is reliable. As illustrated in FIG. 2, a URL associated with a commercial search engine is associated with ‘Request1’ which may indicate that a stored response associated with‘Request1’ must be treated according to a pre-determined set of rules. For example, reliability or credibility of a resource may determine whether an organic result is presented, whether a sponsored result is presented, etc. In at least one embodiment, a resource associated with an organic answer may affect whether a sponsored answer is provided.

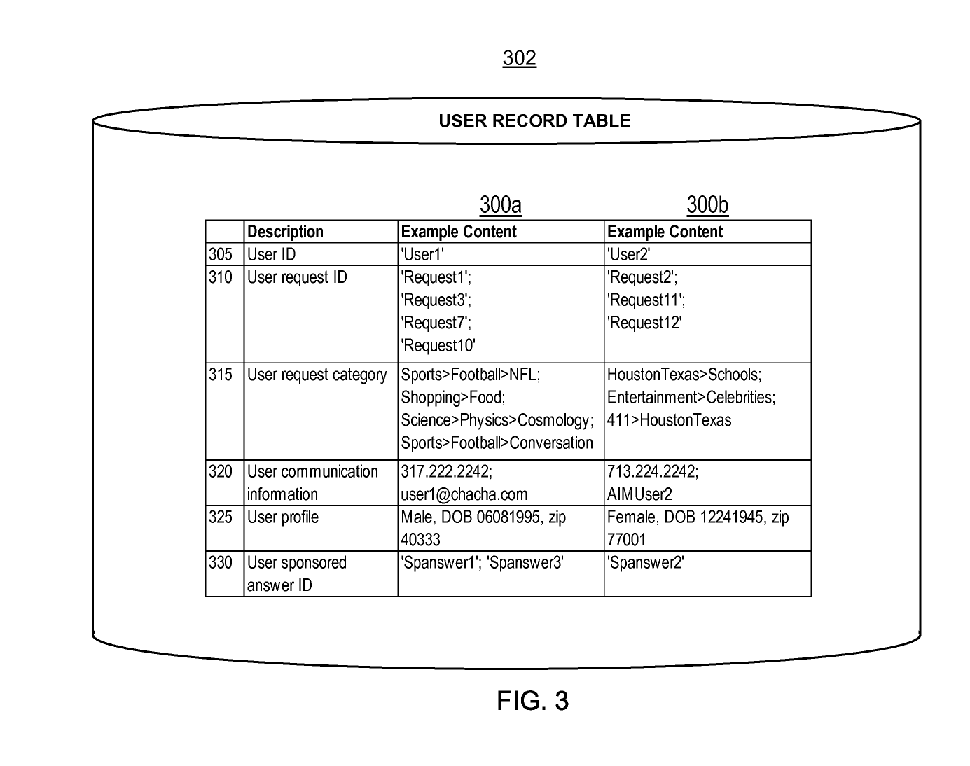

As illustrated in FIG. 3 an exemplary user record table 302, which may comprise a number of user records of which one or more may be associated with or resident in the database 120 (FIG. 1) is provided. The user record table 302 may include information of users. User records may include a user ID field 305, a user request ID field 310, a user request category field 315, a user communication information field 320, a user profile field 325, and a user sponsored answer ID field 330.

The user ID field 305 includes an identifier of a user which is preferably unique and is preferably used consistently. A user ID serves to distinguish a user record associated with a user from a user record associated with other users. Any number of characters, numbers, and/or other indicators may be used to indicate a user ID. In at least one embodiment, a random number is indicated in the user ID field 305. Using the example in FIG. 3, ‘User1’ is the user ID associated with the user record 300a.

The user request ID field 310 may include information of a number of requests associated with a user. A user request ID may be for example a pointer to a request record associated with a request submitted by a user. If a user submits a request, a request ID may be added to the user request ID field 310. Using the example illustrated in FIG. 3, ‘Request2’, ‘Request11’ and ‘Request12’ are associated with ‘User2’ as indicated in the user record 300b. This may indicate that ‘User2’ has submitted ‘Request2’, ‘Request11’ and ‘Request12’.

The user request category field 315 may include information regarding a category or type associated with a user request. For example, if a request is directed to a type of processing or a category, etc. a type and/or category associated with the processing may be indicated in the user request category field 315. In at least one embodiment, the user request ID field 310 and the user request category field 315 are linked by for example a pointer. In at least one embodiment, a category associated with a request of a user may affect whether a sponsored answer will be provided. An affiliation of a user may affect a category associated with a request of a user. For example, if a user is a member of a group affiliated with a primary school, a sponsored answer associated with a query may be modified to be appropriate to that membership.

The user communication information field 320 may include information of a number of communication services associated with a user. Any information which may be used to establish communication with a user may be indicated in the user communication information field 320. For example, a telephone number, an email address, an IM credential, a URL, a username, a password, and/or other communication information may be indicated in the user communication information field 320. Using the example in FIG. 3, the phone number ‘317.222.2242’ and the email ‘user1@chacha.com’ are associated with ‘User1’.

The user profile field 325 may include information of a profile associated with a user. For example, demographic, geographic, affiliation, personality, and/or other types of anthropic and/or other characteristic information may be associated with a user. A user may provide profile information as part of a registration process. User profile information may be obtained from a database provided by a third party. User profile information may be determined based on test, polling, query history, peer review, and/or other information associated with a user. Using the example illustrated in FIG. 3, ‘Female, DOB 12241945, zip 77001’ are associated with ‘User2’. Profile information may be used to match information provided by a user to other information. For example, a ranking of a guide for a query of a user may be adjusted based on a profile associated with the user. A sponsored answer might be modified based on geographic, demographic, etc. profile information of a user.

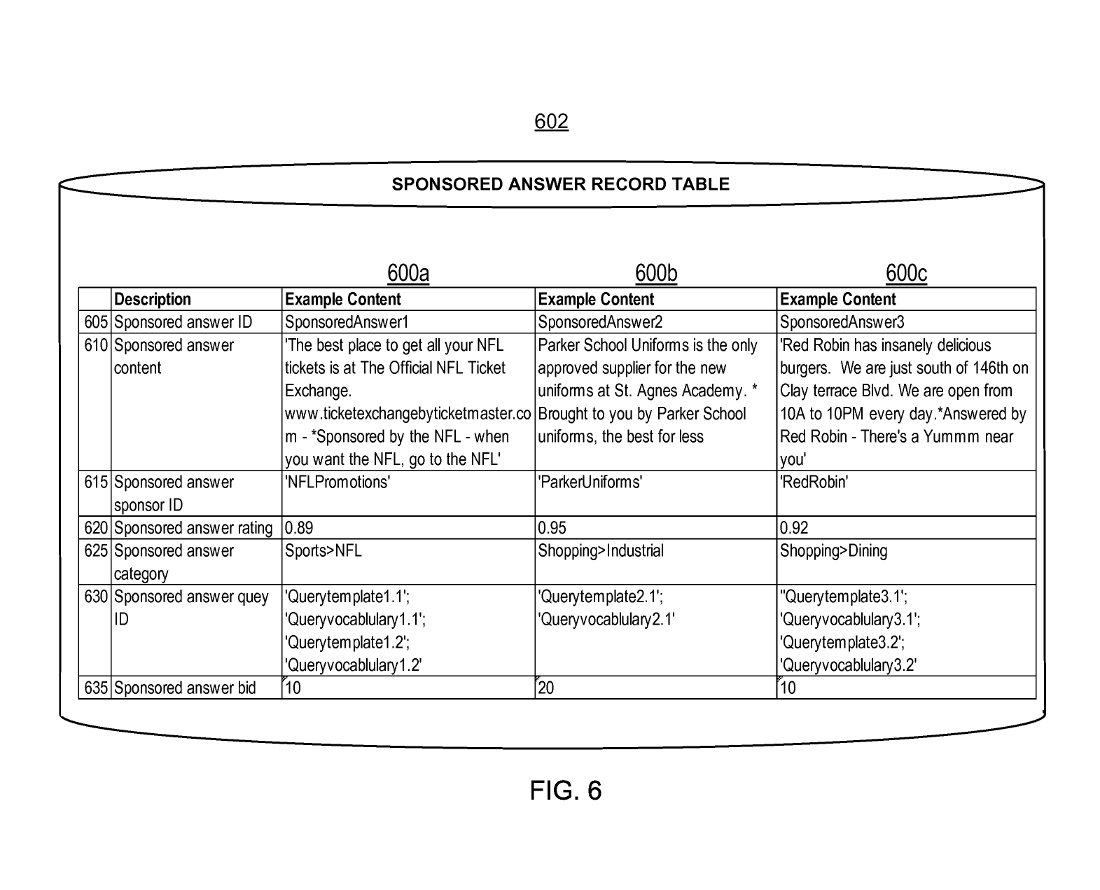

The user sponsored answer ID field 330 may include information of a sponsored answer provided to a user. The user sponsored answer ID field 330 may include an identifier of a sponsored answer record such as the sponsored answer record 600a (FIG. 6). Content of the user sponsored answer ID field 330 may be used to determine compensation. For example, a guide and/or the search system may be compensated based on delivery of a sponsored answer to a user. Content of the user sponsored answer ID field 330 may be used to rank sponsored answers. For example, if a sponsored answer has been previously delivered to a user, or if a predetermined number of sponsored answers have been delivered, or if a competing sponsored answer has been delivered, a ranking of a sponsored answer may be affected.

As illustrated in FIG. 4 an exemplary guide record table 402 which may comprise a number of guide records of which one or more may be associated with or resident in the database 120 (FIG. 1) is provided. The guide record table 402 (FIG. 4) may include information of guides. Guide records may include a guide ID field 405, a guide request ID field 410, a guide request type field 415, a guide rating field 420, a guide communication information field 425, and a guide payment information field 430.

The guide ID field 405 includes an identifier of a guide which is preferably unique and is preferably used consistently. A guide ID serves to distinguish a guide record associated with a guide from a guide record associated with other guides. Any number of characters, numbers, and/or other indicators may be used to indicate a guide ID. In at least one embodiment, a random number is indicated in the guide ID field 405. In at least one embodiment, a pseudonym selected by a guide may be indicated in the guide ID field 405. Using the example in FIG. 4, ‘Guide1’ is the guide ID associated with the guide record 400a.

The guide request ID field 410 may include information of a number of requests associated with a guide. Content of the guide request ID field 410 may be used to obtain information of a request. For example, if a user request has been determined to require a number of requests or tasks to be performed, the search system 130 (FIG. 1) may assign a unique ID to the requests and may distribute information of the requests to guides. Using the example in FIG. 4, ‘Request1’, ‘Request2’, ‘Request24’ and ‘Request102’ are associated with ‘Expediter1’ as indicated in the guide record 400b. This may indicate that ‘Expediter1’ has expedited or handled ‘Request1’, ‘Request2’, ‘Request24’ and ‘Request102’.

The guide request type field 415 may include information of a number of types of requests which may be processed by a guide. For example, a category and/or keyword associated with a request, a type of request, temporal information associated with a request, etc., which may be used to determine if a guide is to be presented with a request may be indicated in the guide request type field 415. In at least one embodiment, a guide may be assigned to a particular type of request as part of a registration process. A guide may select a type of request which the guide may perform. A guide may be required to pass a test in order to be associated with a type of request. A guide may be assigned to a role such as expediter, searcher, etc., which may be indicated in the guide request type field 415. A request indicating a keyword may be directed to a guide. Using the example in FIG. 4, ‘Parker1’ is associated with the keywords ‘St. Agnes Academy’, ‘uniforms’, ‘St. Anne's School’, and ‘approved’. This may for example indicate that ‘Parker1’ may be presented with and/or selected to respond to requests indicating those keywords.

The guide rating field 420 may include information of a number of ratings associated with a guide. For example, quality, speed, peer review, user ratings, earnings, etc., may be used to determine a rating of a guide. A rating of a guide may be used for purposes such as determining compensation for the guide (e.g. bonus points), selecting a guide to respond to a request, matching a request to a guide, etc. In at least one embodiment, the guide request type field 415 and the guide rating field 420 may be linked by, for example, a pointer. Using the example in FIG. 4, ‘Expediter1’ has a rating of ‘0.95’ associated with ‘Expedite’, and a rating of ‘0.88’ associated with ‘Transcribe’ which may be used to rank ‘Expediter1’ versus other guides associated with the request types ‘Expedite’ and ‘Transcribe’.

The guide communication information field 425 may include information of a number of communication services associated with a guide. For example, a user name and password, an email address, an IM credential, a phone number, a web page, a physical address, etc., may be indicated in the guide communication information field 425. Using the example illustrated in FIG. 4, ‘Guide1’ is associated with the login ID ‘guide1’, the email ‘guide1@chacha.com’, the Twitter account ‘twitter.guide1’, and the phone number ‘555.924.2242’. This may indicated that ‘Guide1’ may be contacted using the associated communication services.

The guide payment information field 430 may include information of a payment method associated with a guide. For example, banking information, a PayPal® account, a Western Union® account, etc., may be indicated in the guide payment information field 430. Content of the guide payment information field 430 may be used to provide compensation to a guide. For example, payment may be made by Automated Clearing House (ACH), wire transfer, etc., using information indicated in the guide payment information field 430. As indicated in the guide record 400c (FIG. 4), the guide ‘Parker1’ is associated with ‘ParkerAccount’ which may indicate that the sponsor ‘Parker’ is providing compensation to the guide ‘Parker1’.

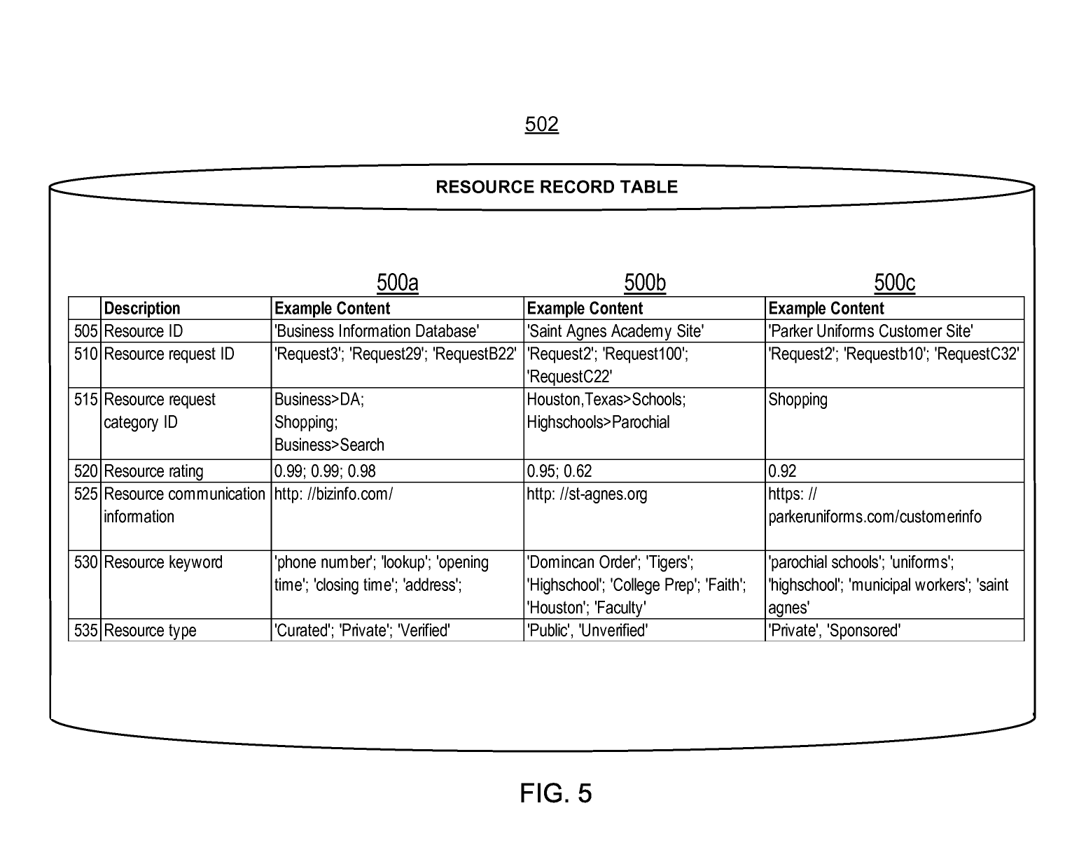

As illustrated in FIG. 5 an exemplary resource record table 502 which may comprise a number of resource records of which one or more may be associated with or resident in the database 120 (FIG. 1) is provided. The resource record table 502 (FIG. 5) may include information of resources. Resource records may include a resource ID field 505, a resource request ID field 510, a resource request category ID field 515, a resource rating field 520, a resource communication information field 525, a resource keyword field 530, and a resource type field 535.

The resource ID field 505 includes an identifier of a resource which is preferably unique and is preferably used consistently. A resource ID serves to distinguish a resource record associated with a resource from a resource record associated with other resources. Any number of characters, numbers, and/or other indicators may be used to indicate a resource ID. Using the example in FIG. 5, ‘Business Information Database’ is the resource ID associated with the resource record 500a. This may indicate that ‘Business Information Database’ has been used to produce a search result, and is accessible to a guide, and/or other authorized persons.

The resource request ID field 510 may include information of a number of requests associated with a resource. Content of the resource request ID field 510 may be used to obtain information of a request. For example, if a resource has been used to respond to a request, an identifier of the request may be indicated in the resource request ID field 510. Using the example in FIG. 5, ‘Request2’, ‘Request100’ and ‘RequestC22’ are associated with the resource ‘Saint Agnes Academy Site’ as indicated in the resource record 500b. This may indicate that ‘Saint Agnes Academy Site’ has been utilized to respond to ‘Request2’, ‘Request100’ and ‘RequestC22’.

The resource request category ID field 515 may include information of a number of categories of requests which may be processed by a resource. For example, a category and/or keyword associated with a request, a type of request, profile, etc., which may be used to determine if a resource is to be presented to a guide for a request may be indicated in the resource request category ID field 515. In at least one embodiment, a resource may be assigned to a category of request as part of a registration process. A resource may be associated with a user, a group of users, an access right, an advertiser or sponsor, etc. A provider of a resource may select a type and/or category of request for which the resource may be used and/or required. A resource may be associated with a category based on a selection by an administrator, based on success rates of obtaining or providing answers, based on usage by guides, etc. Using the example in FIG. 5, ‘Parker Uniforms Customer Site’ is associated with the category ‘Shopping’ as indicated by the resource record 500c.

The resource rating field 520 may include information of a number of ratings associated with a resource. For example, a rating of a resource may be based on ratings of answers produced using the resource, a contractual agreement, an affiliation, temporal information such as time spent by guides, time required to locate an answer, etc. A rating of a resource may be used to select a resource which may be provided to a searcher or guide, to rank a response associated with a resource, to determine whether a query is submitted to a resource, etc. In at least one embodiment, the resource request category ID field 515 and the resource rating field 520 may be linked by, for example, a pointer. Using the example in FIG. 5, ‘Business Information Database’ has a rating of ‘0.99’ associated with ‘Shopping’, and ‘Parker Uniforms Customer Site’ has a rating ‘0.92’, associated with ‘Shopping’ which may indicate that Business Information Database' is more likely to produce an acceptable response for that category. A resource may have a rating corresponding to various categories, types of information, types of tasks, keywords, etc.

The resource communication information field 525 may include information of a number of communication services associated with a resource. For example, a user name and password, an email address, an IM credential, a phone number, a web page, a physical address, etc., may be indicated in the resource communication information field 525. A communication service indicated in the resource communication information field 525 may for example be used to indicate a service by which a resource may be accessed. Using the example illustrated in FIG. 5, the URL <<http://bizinfo.com/>> is associated with ‘Business Information Database’. This may indicate that a query associated with ‘Business>DA’ may be submitted to that URL by for example an API.

The resource keyword field 530 may include information of a number of keywords associated with a resource. A match to a keyword indicated in the resource keyword field 530 may affect a probability that a request will receive a response associated with a resource. For example, a match may prohibit a query from receiving a result from a resource, may increase a ranking of a resource, may be used to associate a category with a request, may identify a resource to be provided to a guide, etc. In at least one embodiment, keywords included in requests for which a resource has provided an answer may be more highly ranked for a category associated with the query and the resource. A sponsor may select keywords associated with a resource provided by the sponsor. A URL associated with a sponsored resource may be compared to a URL of an organic result. A result of a comparison of a URL of a sponsored answer with a URL of an organic answer may be used to determine whether a sponsored answer and/or an organic answer is provided.

The resource type field 535 may include information of a number of types or characteristics associated with a resource. A type may include an indication of an access right, a commercial arrangement, a preference, quality of content, source of content, etc. A searcher may elect to associate a resource with a type. A system administrator may associate a type with a resource. A provider of a resource may designate a type associated with the resource as part of a registration process. Using the example in FIG. 5, ‘Business Information Database’ is a ‘Verified’, ‘Private’, ‘Curated’ resource. This may indicate that content of the resource is controlled, that the resource is not accessible to the general public, and that the content of the resource is verified to be correct.

As illustrated in FIG. 6 an exemplary sponsored answer record table 602 which may comprise a number of sponsored answer records of which one or more may be associated with or resident in the database 120 (FIG. 1) is provided. The sponsored answer record table 602 (FIG. 6) may include information of sponsored answers. Sponsored answer records may include a sponsored answer ID field 605, a sponsored answer content field 610, a sponsored answer sponsor ID field 615, a sponsored answer rating field 620, a sponsored answer category field 625, a sponsored answer query ID field 630, and a sponsored answer bid field 635.

The sponsored answer ID field 605 includes an identifier of a sponsored answer which is preferably unique and is preferably used consistently. A sponsored answer ID serves to distinguish a sponsored answer record associated with a sponsored answer from a sponsored answer record associated with other sponsored answers. Any number of characters, numbers, and/or other indicators may be used to indicate a sponsored answer ID. Using the example in FIG. 6, ‘SponsoredAnswer1’ is the sponsored answer ID associated with the sponsored answer record 600a.

The sponsored answer content field 610 may include information of content associated with a sponsored answer. Content of the sponsored answer content field 610 may be used to provide a sponsored answer. For example, a pointer to a file or server may be indicated in the sponsored answer content field 610. A sponsored answer may include any type of media, including text, images, video, audio, etc. Content of a sponsored answer may be customized based on a location, demographic, affiliation, and/or other parameters. For example, ‘SponsoredAnswer3’ indicated in the sponsored answer record 600c might be customized based on a location, a date, etc.

The sponsored answer sponsor ID field 615 may include information of a sponsor associated with a sponsored answer. For example, a sponsor ID indicated in the sponsored answer sponsor ID field 615 may be used to look up a sponsor record such as the sponsor record 700a to obtain information regarding a sponsor. A rating or ranking associated with a sponsor may affect a rating associated with a sponsored answer. For example, a sponsored answer associated with a highly ranked sponsor may be more likely to be provided. Similarly, a ranking or rating of a sponsored answer may affect a rating or ranking of a sponsor. For example, if a sponsored answer is presented to but not selected by a guide a rating of the sponsored answer and/or the sponsor may be reduced.

The sponsored answer rating field 620 may include information of a number of ratings associated with a sponsored answer. For example, a rating of a sponsored answer may be based on ratings of users receiving the sponsored answer, selection by guides, a contractual agreement, an affiliation, temporal information such as time spent by guides, etc. A rating of a sponsored answer may be used to select a sponsored answer which is provided to a user, a searcher or guide, to rank a resource or sponsor associated with a sponsored answer, etc. In at least one embodiment, the sponsored answer category field 625 and the sponsored answer rating field 620 may be linked by, for example, a pointer. Using the example in FIG. 6, ‘SponsoredAnswer2’ has a rating of ‘0.95’ as indicated by the sponsored answer record 600b. A sponsored answer may have a rating corresponding to various categories, types of information, types of tasks, keywords, queries, locations, profiles, etc. A better rating may increase a probability that a sponsored answer may be provided such as to a user, guides, etc.

The sponsored answer category field 625 may include information of a number of categories associated with a sponsored answer. For example, a category associated with a sponsor and/or a sponsored answer may be indicated in the sponsored answer category field 625. A category indicated in the sponsored answer category field 625 may for example be used to rank a sponsor and/or a sponsored answer for a query associated with a category indicated in the sponsored answer category field 625.

The sponsored answer query ID field 630 may include information of a number of queries associated with a sponsored answer. A match to a query indicated in the sponsored answer query ID field 630 may affect a probability that a request will receive a response associated with a sponsored answer. For example, a match may prohibit a query from receiving a result from a sponsored answer, may increase a ranking of a sponsored answer, may be used to associate a category with a request, may identify a sponsored answer to be provided to a guide, etc. In at least one embodiment, a match between a query indicated in the sponsored answer query ID field 630 and a request may increase a ranking of a sponsored answer associated with the query. A programmatic template may be indicated in the sponsored answer query ID field 630. For example, ‘SponsoredAnswer1’ is associated with ‘Querytemplate1.1’ and ‘Queryvocabulary1.1’ as well as ‘Querytemplate1.2’ and ‘Queryvocabulary1.2’ which may be used to generate queries to match a user request to an answer.

The sponsored answer bid field 635 may include information of a number of bids associated with a sponsored answer. A bid may be associated with any parameters associated with a sponsored answer. A bid may be compared to other bids associated with sponsored answers matching a request and may affect a probability that a sponsored answer will be provided. For example, a ranking of sponsored answers for a location may be affected by a bid associated with a location and the sponsored answer. Likewise, bids might be associated with a keyword, query, demographic, etc. information which may be determined for a query.

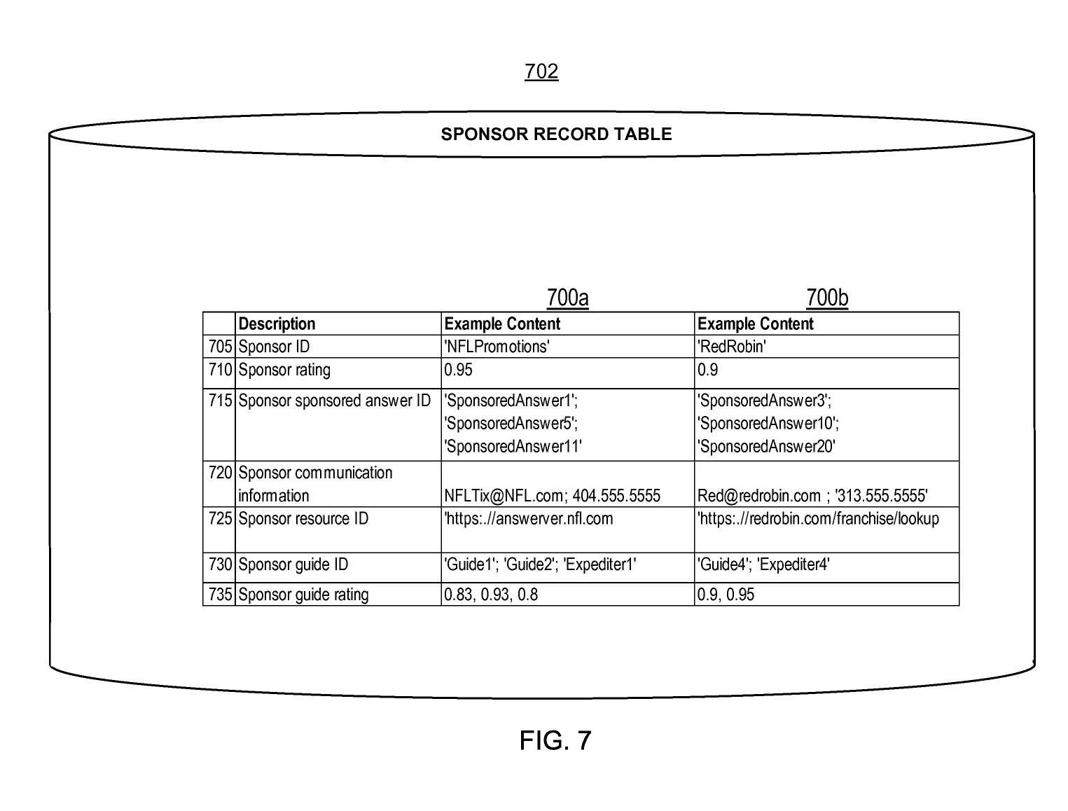

As illustrated in FIG. 7 an exemplary sponsor record table 702 which may comprise a number of sponsor records of which one or more may be associated with or resident in the database 120 (FIG. 1) is provided. The sponsor record table 702 (FIG. 7) may include information of sponsors. Sponsor records may include a sponsor ID field 705, a sponsor rating field 710, a sponsor sponsored answer ID field 715, a sponsor communication information field 720, a sponsor resource ID field 725, a sponsor guide ID field 730, and a sponsor guide rating field 735.

The sponsor ID field 705 includes an identifier of a sponsor which is preferably unique and is preferably used consistently. A sponsor ID serves to distinguish a sponsor record associated with a sponsor from a sponsor record associated with other sponsors. Any number of characters, numbers, and/or other indicators may be used to indicate a sponsor ID. Using the example in FIG. 7, ‘NFLPromotions’ is the sponsor ID associated with the sponsor record 700a.

The sponsor rating field 710 may include information of a rating associated with a sponsor. Content of the sponsor rating field 710 may be user to rank a sponsor for a request. A sponsor rating may be based on factors such as a number of sponsored answers delivered to a user and/or guide, a selection and/or rating of a sponsored answer by a user and/or a guide, a location, a rating of a resource provided by a sponsor, a contractual arrangement, etc. If a sponsored answer is rejected by a system administrator, a guide, etc. a rating of a sponsor may be affected. If a sponsored answer is selected as an organic result, a rating of a sponsor may be affected. Using the example in FIG. 7, ‘RedRobin’ has a rating of ‘0.9’. A sponsor rating may be associated with a keyword, a category, a type of query, a location, gender, age, and/or other information which may be associated with a user, a guide, and/or a query.

The sponsor sponsored answer ID field 715 may include information of a number of sponsored answers associated with a sponsor. Information indicated in the sponsor sponsored answer ID field 715 may be used to obtain information of a sponsored answer. For example an identifier of a sponsored answer record such as the sponsored answer record 600a (FIG. 6) may be indicated in the sponsor sponsored answer ID field 615. Using the example in FIG. 7, ‘RedRobin’ is associated with ‘SponsoredAnswer3’, ‘SponsoredAnswer10’ and ‘SponsoredAnswer20’.

The sponsor communication information field 720 may include information of a number of communication services associated with a sponsor. Content of the sponsor communication information field 720 may be used for various purposes. Reports may be delivered to an email address associated with a sponsor. A login ID associated with a sponsor may allow a sponsor to login to the search system 130 (FIG. 1). For example, a sponsor may search a database provided by the search system 130. Any communication service associated with a sponsor may be utilized. For example, text messaging, voice messaging, IM, etc. might be used to provide status information to a sponsor. As illustrated in FIG. 7, the sponsor record 700a indicates that ‘NFLPromotions’ is associated with the email ‘NFLTix@NFL.com’ and the phone number ‘404.555.5555’.

The sponsor resource ID field 725 may include information of a number of resources provided by a sponsor. Content of the sponsor resource ID field 725 may be used for various purposes. A resource indicated in the sponsor resource ID field 725 may receive a query from a user and/or a guide which may be used to produce a sponsored answer. A resource indicated in the sponsor resource ID field 725 may be provided to a guide such as an expediter, searcher and/or auditor to process a request and/or produce a sponsored answer responsive to a request. A URL of a resource indicated in the sponsor resource ID field 725 may be examined to determine a rating of a search result. Using the example in FIG. 7, <<https:.//answerver.nfl.com>> is associated with ‘NFLPromotions’.

The sponsor guide ID field 730 may include information of a number of guides associated with a sponsor. Content of the sponsor guide ID field 730 may be used for various purposes. A guide indicated in the sponsor guide ID field 730 may be selected to perform a task associated with a sponsor. If a guide selects a sponsored answer, produces a sponsored answer, rejects a sponsored answer, etc. an indicator of the guide may be included in the sponsor guide ID field 730. In at least one embodiment, a guide indicated in the sponsor guide ID field 730 is exclusively controlled by the sponsor. Using the example in FIG. 7, the guides ‘Guide4’ and ‘Expediter4’ are associated with ‘RedRobin’ as indicated in the sponsor record 700b.

The sponsor guide rating field 735 may include information of a number of ratings associated with a guide and a sponsor. Content of the sponsor guide rating field 735 and the sponsor guide ID field 730 may be linked by for example a pointer. Content of the sponsor guide rating field 735 may be used for various purposes. A rating associated with a guide may be used to select a guide to produce, review, select, and/or process a sponsored answer associated with the sponsor. As illustrated in FIG. 7, ‘Guide1’ has a rating ‘0.83’, ‘Guide2’ has a rating ‘0.93’ and ‘Expediter1’ has a rating ‘0.8’ associated with ‘NFLPromotions’. This may for example indicate that ‘Guide2’ is more likely to be selected for a task associated with ‘NFLPromotions’.

While particular groupings, structures and linkages of information have been used for the purposes of illustration no limitation is implied. Other equivalent data constructs and structures which would readily occur to one of ordinary skill in the relevant art may be used to implement the records and tables described herein as would be required for the operation of the embodiments disclosed herein. Any of the records described may include additional fields and any of the fields may be blank or empty.

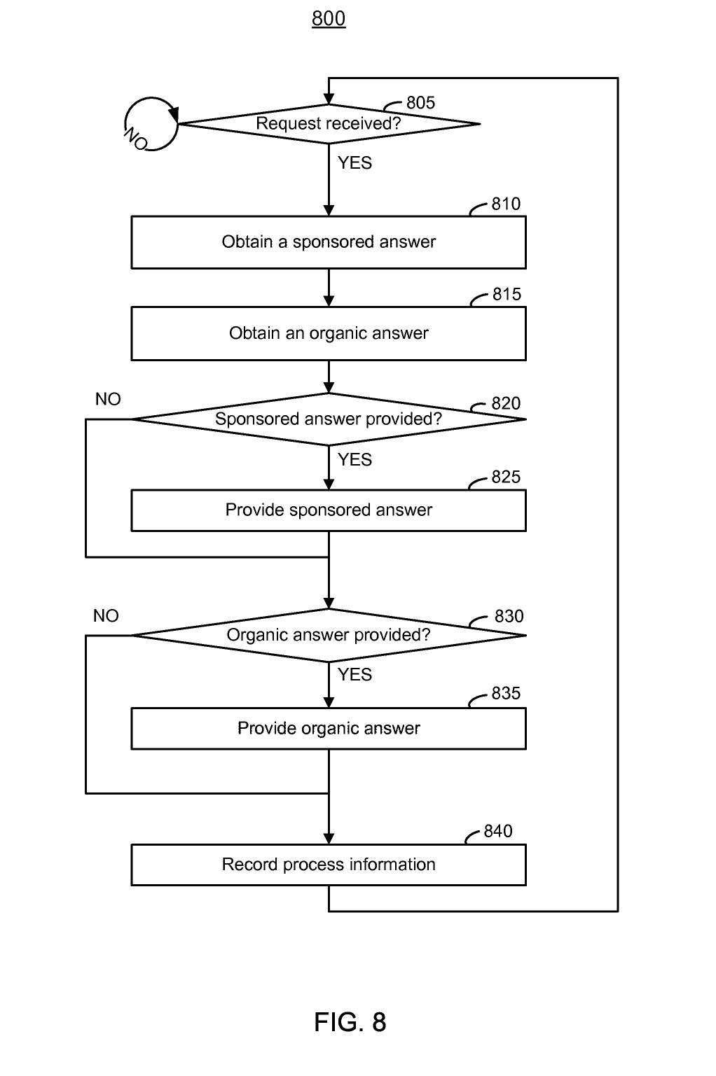

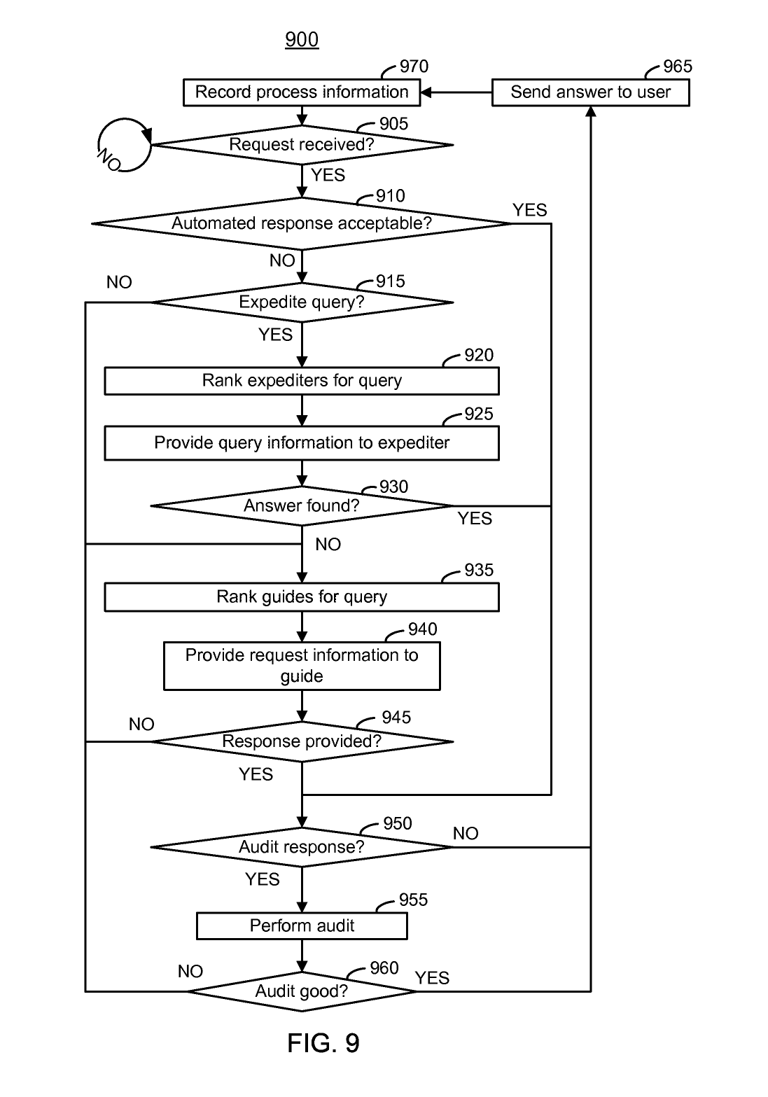

As illustrated in FIG. 8, a process 800 for providing an answer is provided. The process 800 may be performed in whole or in part by any suitable element of the system 100 (FIG. 1). In at least one embodiment, the process 800 is operative on a server associated with the search system 130. A request may be a request for an automated answer, a human assisted answer and/or a combination thereof. The process 800 may be incorporated with a process such as the process 900 (FIG. 9). The process 800 may be used to provide an organic result and/or a sponsored result responsive to a request.

In operation 805 (FIG. 8) a determination is made as to whether a request is received. If it is determined in operation 805 that a request is not received, control remains at operation 805 and process 800 continues. If it is determined in operation 805 that a request is received, control is passed to operation 810 and process 800 continues.

The determination in operation 805 may be made using various criteria. In at least one embodiment, if a message is received at a system associated with the search system 130 (FIG. 1), it may be determined that a request is received. For example, if an email message, an SMS, EMS, and/or MMS message, an IM, an IP message, and/or a voice message is received at an address associated with the search system 130, it may be determined that a request is received. If a message is received at a server associated with the search system 130, it may be determined that a request is received.

In operation 810 a sponsored answer is obtained. A sponsored answer may be obtained programmatically using a database, software application, stored information, etc. A sponsored answer may be obtained from a resource. For example, a query may be submitted to a resource, a guide may select media provided by a resource, a sponsor and/or provider of a resource may obtain an answer from the resource, etc. A sponsored answer may be obtained by a guide. A guide may select a sponsored answer from a list, may obtain a sponsored answer from a public and/or private resource. A guide may be required to obtain a sponsored answer from a predetermined resource. Any number of sponsored answers may be obtained. Control is passed to operation 815 and process 800 continues

In operation 815 an organic answer is obtained. An organic answer may be obtained in any suitable manner. An organic answer may be obtained algorithmically. An organic answer may be obtained from a resource. An organic answer may be obtained by a human searcher. An organic answer may be obtained based on a search using an algorithm which is based on quality metrics of search results without consideration of compensation provided for a search result. Any number of organic answers may be obtained. Control is passed to operation 820 and process 800 continues.

In operation 820 a determination is made as to whether a sponsored answer is provided. If it is determined in operation 820 that a sponsored answer is not provided, control is passed to operation 830 and process 800 continues. If it is determined in operation 820 that a sponsored answer is provided, control is passed to operation 825 and process 800 continues.

The determination in operation 820 may be made based on various criteria. If a rating of a sponsored answer is below a predetermined threshold, it may be determined that a sponsored answer is not provided. A rating of a sponsored answer may be based on factors such as user acceptance, guide selection, bidding, etc. If a sponsored answer has been previously provided, it may be determined that a sponsored answer is not provided. For example, if a user has received a sponsored answer previously in response to a similar query, or if a sponsored answer has been provided more than a predetermined number of times, or if a time interval associated with a sponsored answer is unsuitable, it may be determined that a sponsored answer is not provided. If a query associated with a sponsored answer is not a suitable match to a request, it may be determined that a sponsored answer is not provided. A match to a request may be based on content of a query, geographic information, demographic information, etc. associated with a request. If a sponsored answer differs from an organic result, the sponsored may be provided. A comparison of a sponsored answer to an organic answer may be performed in various ways. For example, a Uniform Resource Locator (URL) associated with a sponsored answer may be compared to a URL associated with an organic result to determine whether an organic result differs from a sponsored result. A portion or segment of content associated with a sponsored result may be compared to a portion of content associated with an organic result to determine whether a sponsored result differs from an organic result. A response may be compared to an answer using techniques such as semantic analysis, image analysis, etc., which may alone or in combination determine whether an answer differs from a response. A determination that a sponsored answer is to be provided may be based on a comparison of a sponsored answer to an organic answer.

In operation 825, a sponsored answer is provided. Any number of sponsored answers may be provided. A highest ranking sponsored answer may be provided. A sponsored answer may be provided in an order based on ranking. A sponsored answer may include a notification of sponsorship associated with the sponsored answer. A ranking of a sponsored answer may be based on ratings of the sponsored answer. Control is passed to operation 830 and process 800 continues.

In operation 830 a determination is made as to whether an organic answer is provided. If it is determined in operation 830 that an organic answer is not provided, control is passed to operation 840 and process 800 continues. If it is determined in operation 830 that an organic answer is provided, control is passed to operation 835 and process 800 continues.

The determination in operation 830 may be made based on various criteria. If a rating of an organic answer is below a predetermined threshold, it may be determined that an organic answer is not provided. If an organic answer is equivalent to a sponsored answer, it may be determined that an organic answer is not provided. If an organic answer is associated with a resource designated by a sponsor, it may be determined that an organic answer is not provided.

In operation 835, an organic answer is provided. Any number of organic answers may be provided. A highest ranking organic answer may be provided. An organic answer may be provided in an order based on ranking. An organic answer may include a notification of a source of the organic answer. A ranking of an organic answer may be determined based on ratings of an organic answer. A rating of an organic answer may be produced using programmatic analysis and/or human assistance, which excludes access to information of compensation associated with an organic answer. Control is passed to operation 840 and process 800 continues.

In operation 840, process information is recorded. Information of a request, a sponsored answer, an organic answer, a resource, a user, a sponsor, a guide, a rating, a ranking, etc. may be recorded. A response may be rated, ranked, or deleted. Usage and compensation associated with a sponsored answer may be recorded. In at least one embodiment, process information is recorded in the database 120 (FIG. 1). Control is passed to operation 805 and process 800 continues.

As illustrated in FIG. 9, a process 900 for responding to a request is provided. The process 900 may be performed in whole or in part by any suitable element of the system 100 (FIG. 1). In at least one embodiment, the process 900 is operative on a server associated with the search system 130.

In operation 905 (FIG. 9) a determination is made as to whether a request is received. If it is determined in operation 905 that a request is not received, control remains at operation 905 and process 900 continues. If it is determined in operation 905 that a request is received, control is passed to operation 910 and process 900 continues.

The determination in operation 905 may be made using various criteria. In at least one embodiment, if a message is received at a system associated with the search system 130 (FIG. 1), it may be determined that a request is received. For example, if an email message, an SMS, EMS, and/or MMS message, an IM, an IP message, and/or a voice message is received at an address associated with the search system 130, it may be determined that a request is received. In at least one embodiment, if a message is received at a server associated with the search system 130, it may be determined that a request is received.

In operation 910 (FIG. 9) a determination is made as to whether an automated response is acceptable. If it is determined in operation 910 that an automated response is acceptable, control is passed to operation 950 and process 900 continues. If it is determined in operation 910 that an automated response is not acceptable, control is passed to operation 915 and process 900 continues.

The determination in operation 910 may be made in various ways. For example, a query may be compared to a template, a Regular Expression (RegEx) expression, a historical query, etc. in order to determine whether an automated response is acceptable. An automated response may be any response that is produced by sending a query to a system which retrieves information without intervention by a person. For example, a search engine, an RSS feed, a database look-up of a query, a program resident on a computer system and/or other programmatic system for retrieving information may provide an automated response. In at least one embodiment, an automated response is received based on the process 800 (FIG. 8). Any suitable criteria may be used to determine whether an automated response is acceptable.

In operation 915 a determination is made as to whether a query is to be expedited. If it is determined in operation 915 that a query is to be expedited, control is passed to operation 920 and process 900 continues. If it is determined in operation 915 that a query is not to be expedited, control is passed to operation 935 and process 900 continues.

The determination in operation 915 may be made according to various criteria. An expediter may not be used for all queries originating from a particular source or user. If a query is associated with a predetermined category, is determined to be temporal in nature, is determined to be complex, etc., it may be determined that a query is not to be expedited. A number and/or type of available expediters may be used to determine whether a query is to be expedited. For example, if an expediter affiliated with a type of user is not available, a query might be directed to a searcher directly if an affiliated searcher is available. If a sponsored answer is not obtained, it may be determined that a query is to be expedited. Any suitable criteria may be used to determine whether a query is to be expedited.

In operation 920 expediters are ranked for a query. In at least one embodiment, a first available expediter may be a highest ranked expediter. An expediter may be ranked based on a type, category, rating, profile, query, sponsor, etc. In at least one embodiment, an expediter is selected based on a bid, such as a bid by a sponsor. Control is passed to operation 925 and process 900 continues.

In operation 925, information of a query is provided to an expediter. Any number of expediter guides may be provided with information of a query. An expediter may be provided with a list of queries associated with the query. An expediter may be provided with information associated with a stored result, a rendering of a web page associated with the stored result, a rendering of a current web page obtained from a location associated with the stored result, etc. An expediter may be selected to provide an organic result, a sponsored result, or both. Control is passed to operation 930 and process 900 continues.

In operation 930, a determination is made as to whether an answer is found. If in operation 930 it is determined that an answer is found, control is passed to operation 950 and process 900 continues. If in operation 930 it is determined that an answer is not found, control is passed to operation 935 and process 900 continues.

The determination in operation 930 may be made based on various criteria. If an expediter selects a response based on a previous query, confirms a query can be answered programmatically, indicates that a query must be searched, fails to respond, responds in agreement with other expediters, etc. it may be determined that an answer is found. For example, if an expediter indicates that a response is contradicted by a web page obtained from a reference location, it may be determined that an answer is not found. If an expediter determines that an answer is found, a verification process may be performed. Any suitable criteria may be used to determine whether an answer is found.

In operation 935, guides are ranked for a query. A guide may be ranked based on any suitable criteria such as response time, historical activity, percentage and/or number of responses, notifications accepted, responses accepted, categories and/or keywords associated with a guide, temporal information, a profile, etc. Similarly, a guide who has responded to and/or accepted a high percentage of notifications or requests may be ranked higher. A quality rating of a guide may be used to rank a guide. A guide may be selected based on a bid of a sponsor. For example, a guide may be selected to provide a sponsored answer based on a ranking based on a bid by a sponsor associated with a guide. A bid may be associated with a guide explicitly and/or may be based on profile information such as gender, location, personality, affiliation, and/or other demographic, geographic, personality, historical, etc. information of a guide. Control is passed to operation 940 and process 900 continues.

In operation 940, information of a request is provided to a guide. For example, a highest ranking guide to respond to a request may be provided with a query, information of resources, information of matching previous requests, information of a user submitting a request, etc. A guide may be provided with information associated with a sponsor if the guide is selected to provide a sponsored answer. Control is passed to operation 945 and process 900 continues.

In operation 945, a determination is made as to whether a response is provided. If in operation 945 it is determined that a response is not provided, control is passed to operation 935 and process 900 continues. If in operation 945 it is determined that a response is provided, control is passed to operation 950 and process 900 continues.

The determination in operation 945 may be made based on various criteria. If a guide does not provide a search result within a predetermined period of time, it may be determined that a response is not provided. If a guide indicates completion of a search, it may be determined that a response is provided. If a plurality of guides responded to a request, a response by one or more guides may indicate that a response is provided. Any suitable criteria may be used to determine whether a response is provided.

In operation 950, a determination is made as to whether a response is to be audited. If in operation 950 it is determined that a response is not to be audited, control is passed to operation 965 and process 900 continues. If in operation 950 it is determined that a response is to be audited, control is passed to operation 955 and process 900 continues.

The determination in operation 950 may be made based on various criteria. For example, a random sample of automated and/or stored answers might be audited. Sampling might be based on a category of request, a resource associated with a response, an expediter and/or searcher, etc. Similarly, a type of user, a commercial relationship, a resource used, etc. might be used to determine whether a response is to be audited. A sponsor may determine whether a sponsored answer is to be audited. Any suitable criteria may be used to determine whether a response is to be audited.

In operation 955, an audit is performed. An audit may include an automated process wherein a stored result is verified based on media obtained from a resource associated with the answer. An audit may include checking and/or comparison of a stored result to a result obtained from a file returned by a resource associated with a stored answer including a review by a person. An audit may include a searcher performing a search for a query, which may be compared to a stored result. An audit may be performed after an answer has been provided. An audit may be performed in real-time. Control is passed to operation 960 and process 900 continues

In operation 960, a determination is made as to whether an audit is good. If in operation 960 it is determined that an audit is good, control is passed to operation 965 and process 900 continues. If in operation 960 it is determined that an audit is not good, control is passed to operation 935 and process 900 continues.

The determination in operation 960 may be made based on various criteria. A failure of an automated comparison, a rejection of a stored result by a guide, a mismatch of a searcher result with a stored result, etc. may be used to determine that an audit is not good. Likewise, a guide and/or an automated analysis may determine that an audit is good. If a time period for a real-time audit has elapsed, it may be determined that an audit is good. Any suitable criteria may be used to determine whether an audit is good.

In operation 965, an answer is sent to a user. An answer may be delivered to a user via any communication service associated with the user. An answer may include any media which may be delivered using a communication service and a device of the user. For example, an SMS message might be delivered to a user mobile device. Any number of responses may be delivered to a user as any or all of an organic answer and/or a sponsored answer. Control is passed to operation 970 and process 900 continues

In operation 970, process information is recorded. Information regarding any item such as a user, a guide, a request, a resource, an advertisement, a user, keyword, category, etc. may be recorded and/or updated. For example, a rating may be adjusted, a keyword, category, type, guide, sponsor, resource, time, user, answer, etc. of a request may be recorded. A rating and/or ranking of an item may be updated and/or modified. A stored response may be rated, ranked, or deleted. In at least one embodiment, process information is recorded in the database 120 (FIG. 1). Control is passed to operation 905 and process 900 continues.

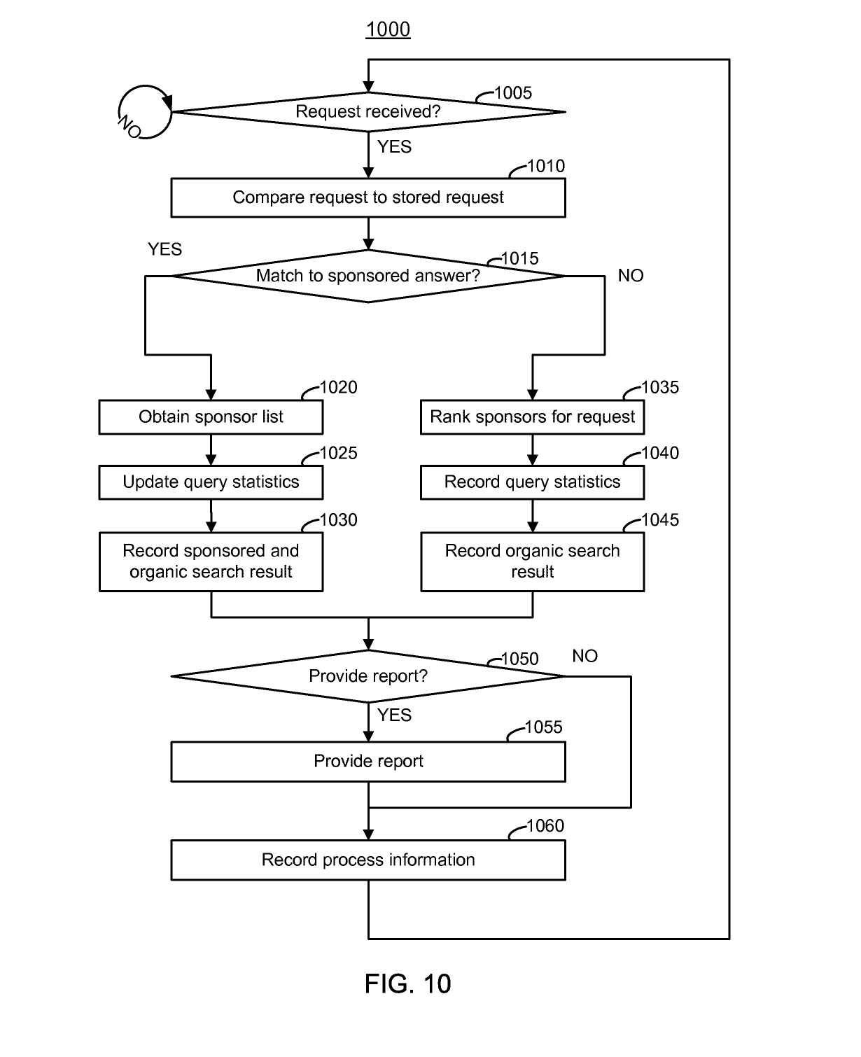

As illustrated in FIG. 10, a process 1000 for responding to a request is provided. The process 1000 may be used to provide information to sponsors regarding items such as queries, users, etc. The process 1000 may be performed in whole or in part by any suitable element of the system 100 (FIG. 1). In at least one embodiment, the process 1000 is operative on a server associated with the search system 130. For example, a sponsor may request information using a web browser functionality of a sponsor system from a server associated with the search systems 130.

In operation 1005 (FIG. 10) a determination is made as to whether a request is received. If it is determined in operation 1005 that a request is not received, control remains at operation 1005 and process 1000 continues. If it is determined in operation 1005 that a request is received, control is passed to operation 1010 and process 1000 continues.

The determination in operation 1005 may be made using various criteria. In at least one embodiment, if a message is received at a system associated with the search system 130 (FIG. 1), it may be determined that a request is received. For example, if an email message, an SMS, EMS, and/or MMS message, an IM, an IP message, and/or a voice message is received at an address associated with the search system 130, it may be determined that a request is received. In at least one embodiment, if a message is received at a server associated with the search system 130, it may be determined that a request is received.

In operation 1010 a request is compared to a stored request. A comparison may include comparison to previous queries, stored templates, keywords, named entities, categories, users, guides, profiles, etc. associated with a stored answer. Control is passed to operation 1015 and process 1000 continues.

In operation 1015 a determination is made as to whether a query is a match to a sponsored answer. If it is determined in operation 1015 that a query is not a match to a sponsored answer, control is passed to operation 1035 and process 1000 continues. If it is determined in operation 1015 that a query is a match to a sponsored answer, control is passed to operation 1035 and process 1000 continues.

The determination in operation 1015 may be made based on various criteria. An exact match to a stored query associated with a sponsored answer may be used to determine that a query is a match to a sponsored answer. A match to a keyword, category, profile, named entity, website, etc. associated with a request and/or an organic search result may be used to determine whether a query is a match to a sponsored answer. Any suitable criteria may be used to determine whether a query is a match to a sponsored answer.

In operation 1020 a sponsor list is obtained. Any number of sponsors associated with a sponsored answer matching a request may be obtained. In at least one embodiment, a sponsor associated with a sponsored answer delivered to a user may be selected. Control is passed to operation 1025 and process 1000 continues.

In operation 1025 query statistics are updated. For example, if a request matches a stored answer, a number of times a query and/or answer has been matched, a number of total matches to queries, a number of guide selected sponsored answers, a number of human assisted sponsored answers, etc. may be updated. Control is passed to operation 1030 and process 1000 continues.

In operation 1030 sponsored search result is recorded. If an organic search result is provided responsive to a request, information of the organic search result may be recorded. For example, whether an organic and/or sponsored search result was produced based on stored information, based on a guide selection, based on a search by a guide, etc. may be recorded. A resource associated with an organic answer and/or a sponsored answer may be recorded. Control is passed to operation 1050 and process 1000 continues.

In operation 1035 sponsors are ranked for a request. Any number of sponsors matching a request may be ranked. A ranking of a sponsor for a request may be based on various items. For example, if a sponsor selects a keyword, category, named entity, profile, etc. of which the sponsor may want to receive information, the sponsor may be ranked for a request based on a number of those items. Control is passed to operation 1040 and process 1000 continues.

In operation 1040 query statistics are recorded. For example, if a request matches a stored request, a number of times a query has been matched, a number of total matches to queries, a number of guide selected organic answers, a number of human assisted organic answers, reuse of organic answers, queries associated with any items, etc. may be updated. Control is passed to operation 1045 and process 1000 continues.

In operation 1045 an organic search result is recorded. If an organic search result is provided responsive to a request, information of the organic search result may be recorded. For example, whether an organic result was produced based on stored information, based on guide selection, based on a search by a guide, etc. may be recorded. A resource associated with an organic answer may be recorded. Control is passed to operation 1050 and process 1000 continues.

In operation 1050 a determination is made as to whether a report is provided. If it is determined in operation 1050 that a report is not provided, control is passed to operation 1060 and process 1000 continues. If it is determined in operation 1050 that a report is provided, control is passed to operation 1055 and process 1000 continues.

The determination in operation 1050 may be made based on various criteria. A sponsor may request a report manually from a web page provided by a server associated with the search system 130 (FIG. 1). A sponsor may request that reports be provided periodically such as at the end of each week, month, etc. A sponsor may request a report when a condition is met such as a number of usages of an answer, a change in usage statistics of sponsored answers, queries associated with an item, etc. A sponsor may request any information which is available from the database 120 based on any conditions which can be evaluated by the search system 130.

In operation 1055 a report is provided. A report may be provided to a sponsor, a potential sponsor, or any person and/or entity authorized to receive a report. A report may be delivered by any suitable communication service. A report may be provided electronically using email, IM, SMS, MMS, file transfer protocol (ftp), etc. Control is passed to operation 1060 and process 1000 continues.

In operation 1060, process information is recorded. Information regarding any item such as a user, a guide, a request, a resource, a sponsor, a user, keyword, category, etc. may be recorded and/or updated. For example, a rating may be adjusted, a keyword, category, type, guide, sponsor, resource, time, user, answer, etc. of a request may be recorded. Compensation information, page views, timing of reports, keywords, categories, queries, etc. related to requests by sponsors, etc. may be recorded. In at least one embodiment, process information is recorded in the database 120 (FIG. 1). Control is passed to operation 1005 and process 1000 continues.

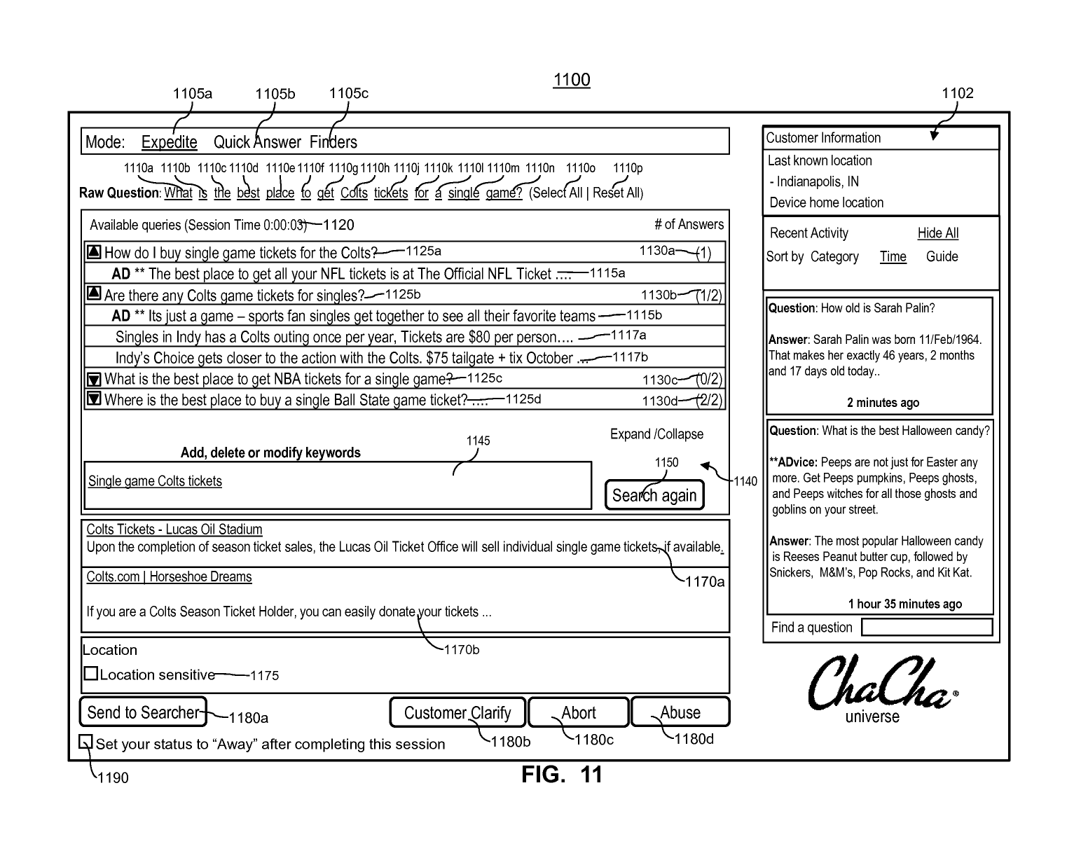

As illustrated in FIG. 11 an expediting GUI 1100 is provided. The expediting GUI 1100 may be provided to a guide selected to expedite a request. The expediting GUI 1100 may be used to obtain a sponsored and/or organic answer. The expediting GUI 1100 may include a customer information window 1102, task indicators 1105a-c, request indicators 1110a-p, sponsored answer indicators 1115a-b, organic answer indicators 1117a-b, session timer 1120, stored query indicators 1125a-d, answer count indicators 1130a-b, a response selection window 1140, a query window 1145, a search control 1150, web search indicators 1170a-b, a location indicator 1175, action controls 1180a-d, and a status indicator 1190.

The customer information window 1102 may include information such as current and/or home location of a user, previous queries, profile information, affiliation information, etc. The task indicators 1105a-c may be activated to select a GUI for a task. The ‘Expedite’ task indicator 1105a is active as indicated by the underline. Any form of indication of activity such as color, etc. may be used within the scope of the embodiments. Activation of the ‘Finders’ task indicator 1105c may cause a GUI (not shown) associated with a data feed to be provided. The request indicators 1110 may be used to select a portion of a request. Activation of the ‘Colts’ request indicator 1110h may cause ‘Colts’ to be transferred to the query window 1145. Selection of the ‘Select All’ query indicator 1110o may cause all words indicated in the query indicators 1110a-n to the query window 1145, and activation of the ‘Clear All’ query indicator 1110p may clear the query window 1145.

The session timer 1120 may be used to indicate time spent in a session. The stored query indicators 1125a-d may be used to provide information of stored queries. For example, stored queries matching a query indicated in the query window 1145 may be indicated using the stored query indicators 1125a-d. The sponsored answer indicators 1115a-b may be used to indicate a sponsored answer. For example, the sponsored answer indicator 1115a indicates that the sponsored answer “AD** The best place to get all your NFL tickets is at The Official NFL Ticket.’ is associated with the query ‘How do I buy single game tickets for the Colts?’ indicated by the stored query indicator 1125a. Selection of the sponsored answer indicator 1115a may cause the sponsored answer to be provided responsive to the request indicated in the request indicators 1110a-n.

The organic answer indicators 1117a-b may be used to indicate organic answers associated with a stored query. As illustrated, a sponsored answer indicated by the sponsored answer indicator 1115b, and two organic answers indicated by the organic answer indicators 1117a and 1117b are associated with the stored query ‘Are there any Colts tickets games for singles?’ indicated by the stored query indicator 1125b. The answer count indicators 1130a-d may be used to indicate a number of answers associated with a stored query. For example, the answer count indicator 1130d may indicate that two sponsored answers and two organic answers are associated with the stored request indicated by the stored request indicator 1125d.

The query window 1145 may be used to construct a query. Any or all elements of a user query may be used and/or modified to construct a query in the query window 1145. Activation of the search control 1150 may cause content of the response selection window 1140 to be modified. For example, if a query in the query window 1145 is modified, activation of the search control 1150 may change the stored query indicators 1125a-d, web search indicators 1170a-b, etc. to be updated based on the modified query. The web search indicators 1170a-b may be used to provide information of search results produced by submitting a query to an automated search resource. For example, a query indicated in the query window 1145 might be submitted to a sponsored resource, a public search engine, etc. Selection of the web search indicator 1170a may cause a search result indicated in the web search indicator to be provided responsive to a request.

The location indicator 1175 may be used to indicate that a query is sensitive to location. Activation of the location indicator 1175 may cause a query to be modified based on location information associated with a query. For example, a search of stored information might be modified to increase a ranking of results associated with a location associated with a user device. Activation of the ‘Away’ status indicator 1190 may be used to indicate that no further queries are to be provided after completion of a current session. The action controls 1180a-d may be used to take various actions. Activation of the ‘Send to Searcher’ action control 1180a may cause a query to be sent to a searcher. Activation of the ‘Customer Clarify’ action control 1180b may cause a clarification message to be sent to a user submitting the request. Activation of the ‘Abort’ action control 1180c may cause a session to be terminated. Activation of the ‘Abuse’ action control 1180d may cause a session to be terminated, and a message to be sent indicating that a query is abusive.

While the GUI 1100 is illustrated using a mixture of sponsored and organic or unsponsored answers, it is envisioned that a GUI including solely sponsored and/or solely organic answers might be provided. While a specific indication of a sponsored answer (i.e., ‘AD**’) is used for purposes of illustration, any suitable indication such as color, font, etc. to differentiate a sponsored result from an organic result may be utilized within the scope and spirit of the embodiments herein. In at least one embodiment, a sponsored answer and an organic answer may be provided to a guide without indication, and a ranking of the sponsored answer may be determined based on a preference indicated by the guide.

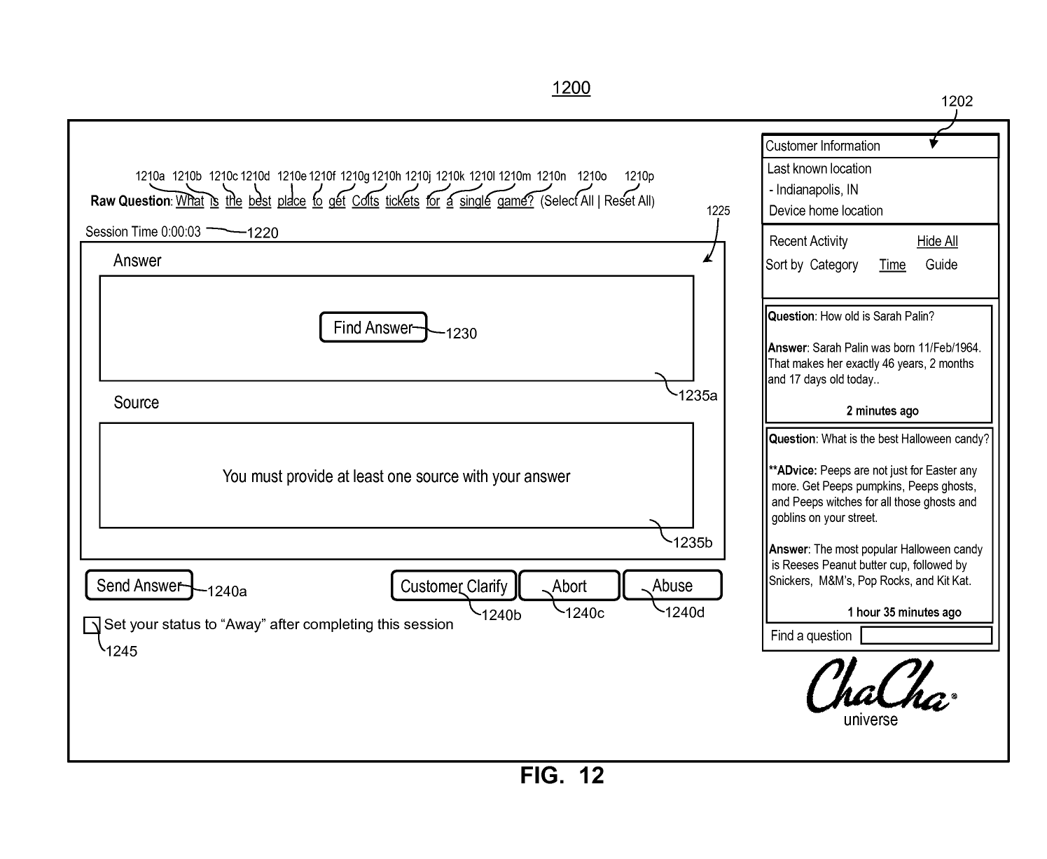

As illustrated in FIG. 12, a searcher GUI 1200 is provided. The searcher GUI 1200 may be provided to a guide when query is directed to the guide for a search. The GUI 1200 may include a customer information window 1202, request indicators 1210a-p, a session timer 1220, an answer composition window 1225, a search button 1230, answer indicators 1235a-b, action controls 1240a-d, and a status indicator 1245.

The customer information window 1202 may include information such as current and/or home location of a user, previous queries, profile information, affiliation information, etc. The request indicators 1210a-p may be used to select a portion of a request. Activation of the ‘Colts’ request indicator 1210h may cause ‘Colts’ to be transferred to the answer indicator 1235a. Selection of the ‘Select All’ query indicator 1210o may cause all words indicated in the query indicators 1210a-n to be transferred to the answer indicator 1235a, and activation of the ‘Clear All’ query indicator 1210p may clear the answer indicator 1235a. The session timer 1220 may be used to indicate time spent in a session.

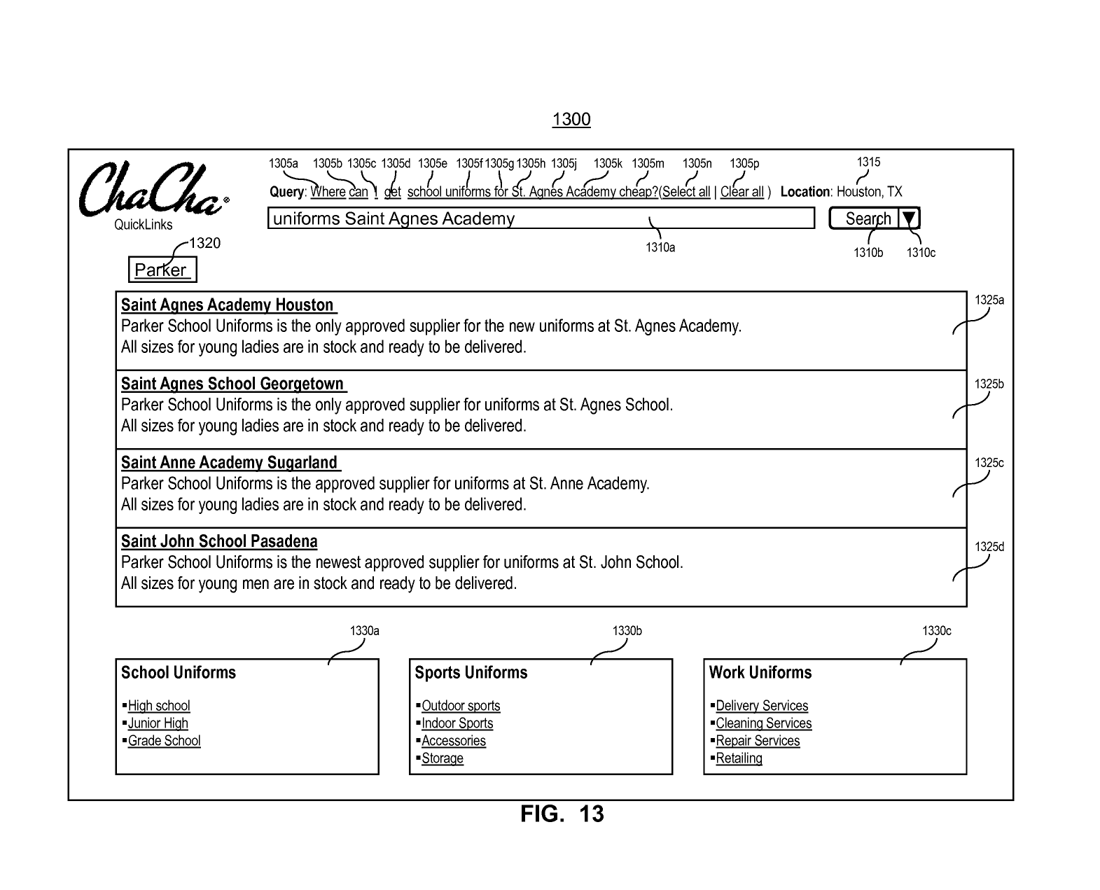

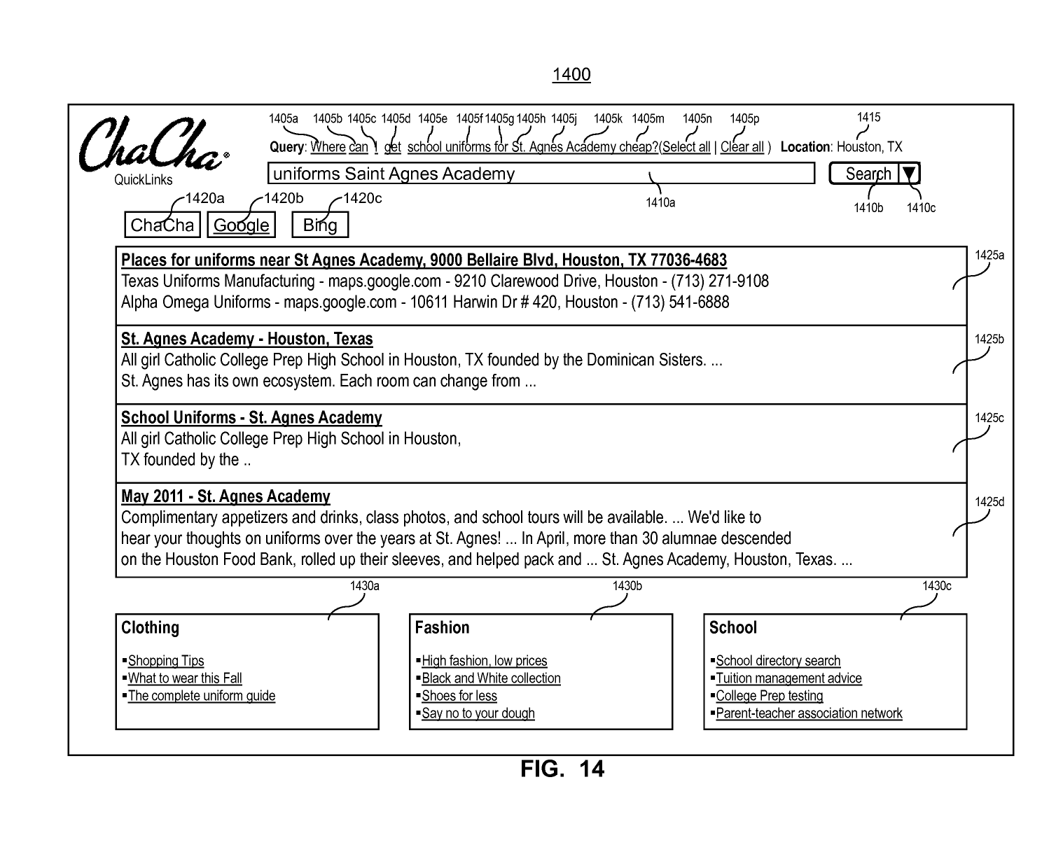

The answer composition window 1225 may be used to construct an answer to a request. Activation of the search button 1230 may cause a GUI such as the GUI 1300 (FIG. 13) and/or the GUI 1400 (FIG. 14) to be provided. The answer indicator 1235a may be used to compose a response to a request. For example, text and/or media obtained from a web page might be transferred to the answer indicator 1235a where it may be edited based on various suitable constraints. The answer indicator 1235b may be used to indicate a source of an answer. For example, when media is obtained from a resource, a location associated with the resource may be copied to the answer indicator 1235b. Any number of answer indicators may be provided.

Activation of the ‘Away’ status indicator 1245 may be used to indicate that no further queries are to be provided after completion of a current session. The action controls 1240a-d may be used to take various actions. Activation of the ‘Send to Searcher’ action control 1240a may cause a query to be sent to a searcher. Activation of the ‘Customer Clarify’ action control 1240b may cause a clarification message to be sent to a user submitting the request. Activation of the ‘Abort’ action control 1240c may cause a session to be terminated. Activation of the ‘Abuse’ action control 1240d may cause a session to be terminated, and a message to be sent indicating that a query is abusive.

As illustrated in FIG. 13, a sponsored search GUI 1300 is provided. The sponsored search GUI 1300 may be provided to a searcher selected to perform a search for a sponsored answer. The GUI 1300 may include request indicators 1305a-p, search controls 1310a-c, a location indicator 1315, a search space indicator 1320, sponsored answer indicators 1325a-d, and sponsored resource indicators 1330a-c.

The request indicators 1305a-p may be used to select a portion of a request. Activation of the ‘uniforms’ request indicator 1305f may cause ‘uniforms’ to be transferred to the search control 1310a. Selection of the ‘Select All’ query indicator 1305n may cause all words indicated in the query indicators 1305a-m to be transferred to search control 1310a, and activation of the ‘Clear All’ query indicator 1305p may clear the search control 1310a. The search control 1310a may be used to enter a search query to be executed on a search space. As illustrated in FIG. 13, ‘uniforms Saint Agnes Academy’ is the query entered in the search control 1310a. The ‘Search’ search control 1310b may be used to execute a search based on content indicated in the search control 1310a and/or the location indicator 1315. The selection search control 1310c may be used to select an algorithm which may be used to perform a search of a search space associated with a sponsor. For example, a keyword weighting, a search corpus, a ranking method, etc. might be selected using the selection search control 1310c. The search space indicator 1320 may be used to select a search space of which a search is performed. As illustrated in FIG. 13, a search of the search space ‘Parker’ may be performed when the search control 1310b is activated.

The sponsored answer indicators 1325a-d may be used to indicate results of a search. For example, a highest ranking result might be indicated by the sponsored answer indicator 1325a. Selection of the sponsored answer indicator 1325a may cause a snippet associated with the sponsored answer to be copied to the answer indicator 1235a (FIG. 12). The sponsored resource indicators 1330 may be used to provide access to resources of a sponsor. For example, the sponsored resource indicator 1330a indicates links associated with ‘School Uniforms’. Activation of a link indicated in the sponsored resource indicators 1330a-c may cause a web page associated with the link to be provided.

As illustrated in FIG. 14, an organic search GUI 1400 is provided. The organic search GUI 1400 may be provided to a searcher selected to perform a search for an organic answer. The GUI 1400 may include request indicators 1405a-p, search controls 1410a-c, a location indicator 1415, search space indicators 1420a-c, organic answer indicators 1425a-d, and organic resource indicators 1430a-c.

The request indicators 1405a-p may be used to select a portion of a request. Activation of the ‘uniforms’ request indicator 1405f may cause ‘uniforms’ to be transferred to the search control 1410a. Selection of the ‘Select All’ query indicator 1405n may cause all words indicated in the query indicators 1405a-n to be transferred to search control 1410a, and activation of the ‘Clear All’ query indicator 1405p may clear the search control 1410a. The search control 1410a may be used to enter a search query to be executed on a search space. As illustrated in FIG. 14, ‘uniforms Saint Agnes Academy’ is the query entered in the search control 1410a. The ‘Search’ search control 1410b may be used to execute a search based on content indicated in the search control 1410a and/or the location indicator 1415. The selection search control 1410c may be used to select an algorithm which may be used to perform a search of a search space or corpus. For example, a keyword weighting, a search corpus, a ranking method, a search engine, etc. might be selected using the selection search control 1410c. The search space indicators 1420 may be used to view search results associated with a search engine and/or search space. As indicated by the underline, the ‘Google’ search space indicator 1420b is active.

The answer indicators 1425a-d may be used to indicate results of a search. For example, a highest ranking result might be indicated by the answer indicator 1425a. Selection of the answer indicator 1425a may cause a snippet associated with the organic answer to be copied to the answer indicator 1235a (FIG. 12). Alternately, a web page associated with the search result indicated might be provided. The organic resource indicators 1430a-c may be used to provide access to resources selected for a search. For example, the organic resource indicator 1430a indicates links associated with ‘Clothing’. Activation of a link indicated in the organic resource indicators 1430a-c may cause a web page associated with the link to be provided.

While the GUI 1300 and the GUI 1400 have been illustrated as separate interfaces, in at least one embodiment, both sponsored and organic results a provided. An indication that a result and/or a resource is sponsored may be provided. In at least one embodiment there is no differentiation of the indication of a sponsored answer and/or resource compared to organic answers and/or generic or public resources.

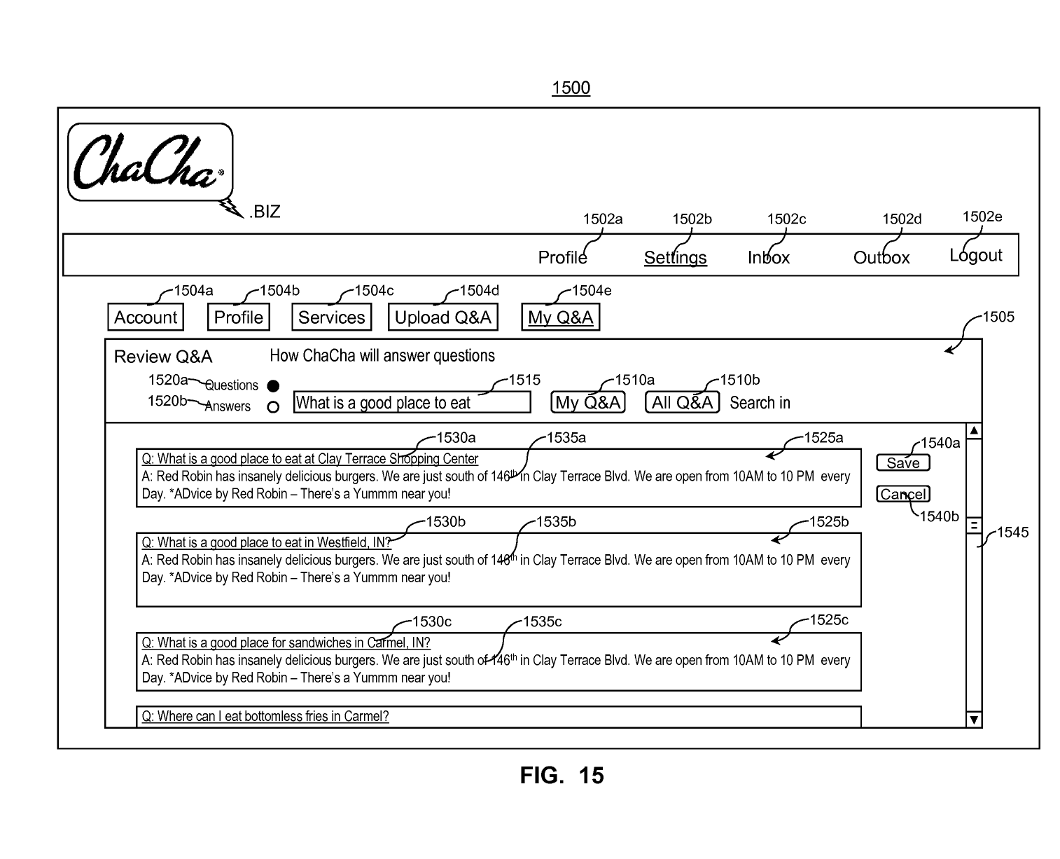

As illustrated in FIG. 15, a sponsored answer GUI 1500 is provided. The GUI 1500 may be used to associate a sponsored answer with a query. The GUI 1500 may be provided to responsive to a request of a sponsor or potential sponsor. The GUI 1500 may include user controls 1502a-e, activity selection indicators 1504a-e, an activity window 1505, search space controls 1510a-b, a search query box 1515, search type indicators 1520a-b, search result windows 1525, stored query indicators 1530a-c, sponsored answer indicators 1535a-c, action controls 1540a-b, and a navigation control 1545.

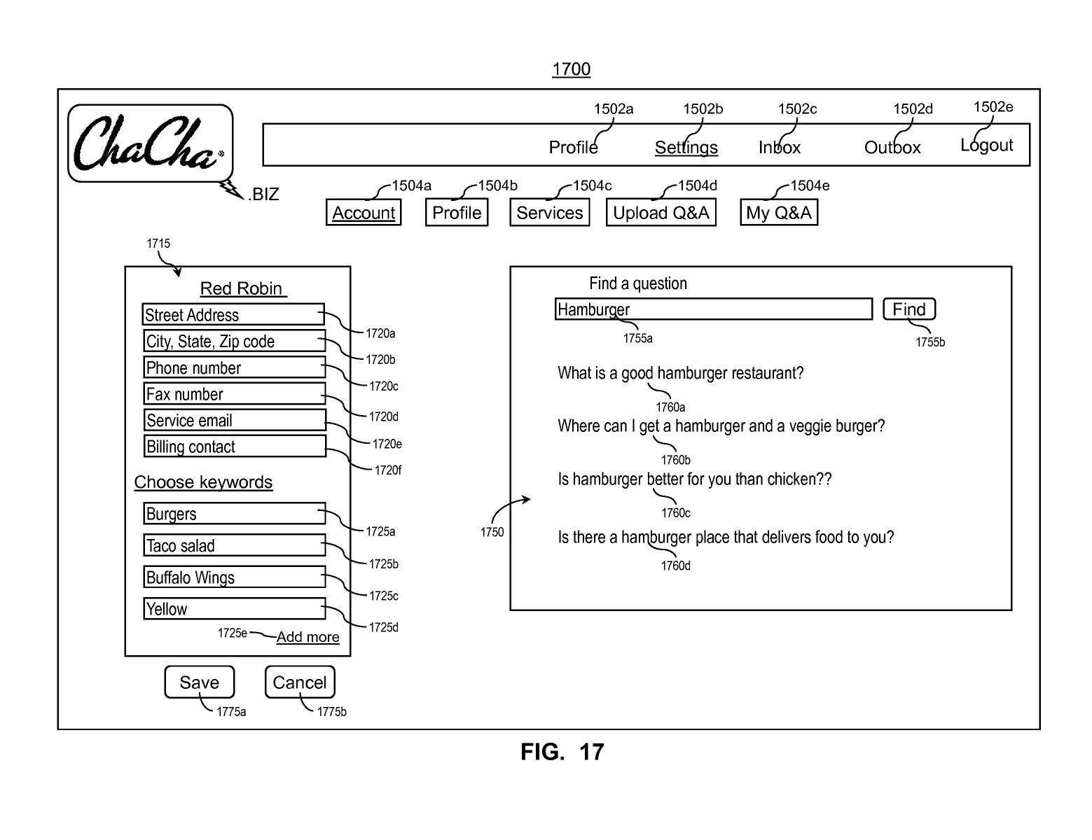

The user controls 1502a-e may be used to indicate an activity. Activation of the ‘Profile’ user control 1502a may cause a profile GUI (not shown) to be provided. Activation of the ‘Settings’ user control 1502b may cause the GUI 1500 to be presented. The user controls 1502c, 1502d, and 1502e may be used to view incoming, and to view outgoing messages, and to logon or logoff respectively. The activity selection indicators 1504a-e may be used to select an activity provided in the activity window 1505. Selection of the ‘Account’ activity selection indicator 1504a may cause the GUI 1700 (FIG. 17) to be provided. Selection of the ‘Upload Q&A’ activity selection control 1504d may cause a GUI (not shown) for uploading of a file including queries and answers associated with the queries to be provided. Activation of the ‘My Q&A’ activity selection indicator 1504e may cause the GUI 1500 to be provided. In FIG. 15, the ‘My Q&A’ activity selection indicator 1504e is active as indicated by the underline.

The search space control 1510a may be used to perform a search of queries and answers associated with a sponsor. The search space control 1510b may be used to perform a search of all queries and answers. The search query box 1515 may be used to indicate a search query for a search of queries and answers. The search type indicators 1520a-b may be used to indicate whether queries or answers are to be searched. The ‘Questions’ search type indicator 1520a is active as indicated by the filled circle. The search result windows 1525a-c may be used to provide information of a query and an answer associated with the query. The stored query indicators 1530a-c may be used to provide information of a stored query returned as a search result. For example, the search result window 1525c provides information regarding the query ‘What is a good place for sandwiches in Carmel, IN?’ as indicated by the stored query indicator 1530c. The sponsored answer indicators 1535a-c may be used to indicate a sponsored answer associated with a stored query. For example, the sponsored answer indicators 1535a, 1535b, and 1535c indicate that the same sponsored answer is associated with each of the queries indicated in the stored query indicators 1530a, 1530b, and 1530c.

The action buttons 1540a-b may be used to take actions regarding information provided in the GUI 1500. The ‘Save’ action control 1540a may be used to record information obtained using the GUI 1500. The ‘Cancel’ action control 1540b may be used to discard information obtained using the GUI 1500. The navigation control 1545 may be used to navigate within content of the activity window 1505.

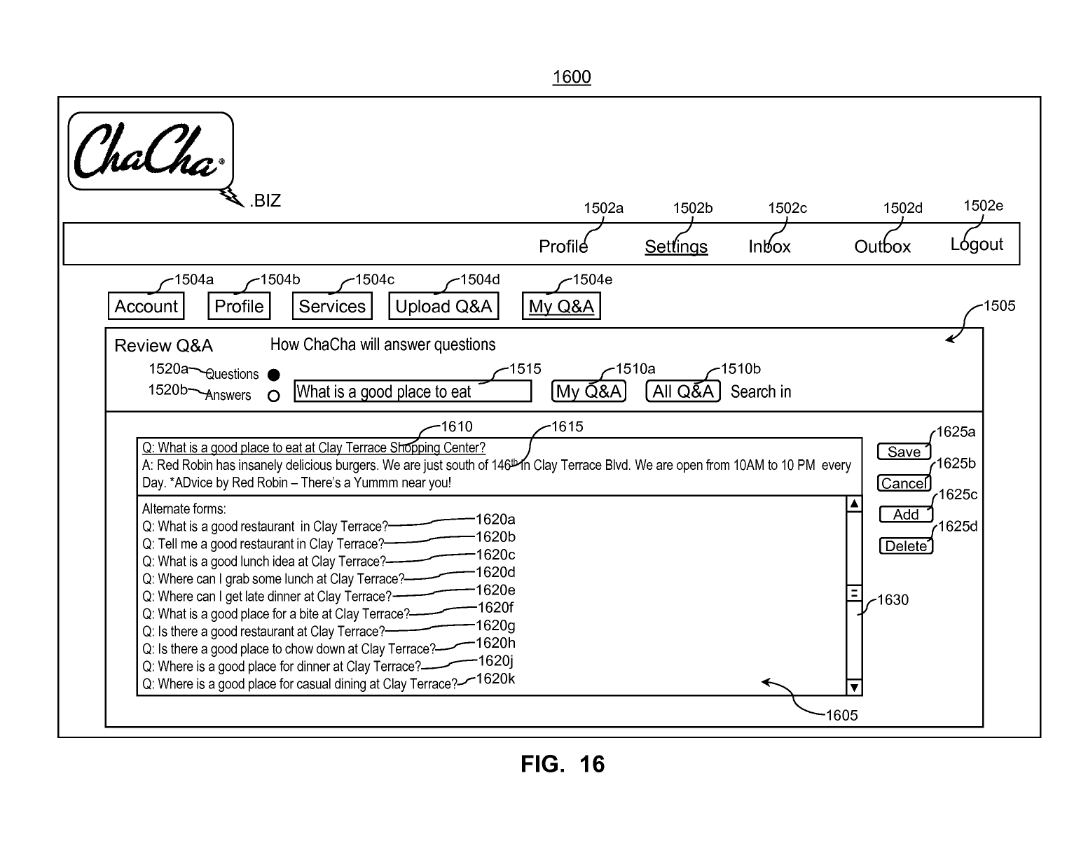

Activation of a stored query indicator may cause a query editing GUI 1600 to be provided. The GUI 1600 may be used to select and/or edit alternate forms of stored queries, templates and vocabularies associated with stored queries and/or sponsored answers, etc. As illustrated in FIG. 16, the GUI 1600 may include user controls 1502a-e, activity selection indicators 1504a-e, an activity window 1505, search space controls 1510a-b, a search query box 1515, search type indicators 1520a-b, an alternate query window 1605, a stored query indicator 1610, a sponsored answer indicator 1615, alternate query form indicators 1620a-k, action controls 1625a-d, and navigation controls 1630.

The alternate query window 1605 may be used to provide information regarding alternative queries which may match a stored query. The stored query indicator 1610 may be used to indicate a stored query to which the alternate forms refer. The sponsored answer indicator 1615 may be used to indicate a sponsored answer associated with a stored query and any alternate queries. The alternate query form indicators 1620a-k may indicate alternate queries associated with a stored query and/or a sponsored answer. Alternate query forms may be generated programmatically based on a stored query, may be associated with a sponsored answer if a guide selects the sponsored answer responsive to the query, may be generated by a sponsor, etc.

The action buttons 1625a-d may be used to take actions regarding information provided in the GUI 1600. The ‘Save’ action control 1625a may be used to record information obtained using the GUI 1600. The ‘Cancel’ action control 1625b may be used to discard information obtained using the GUI 1600. The ‘Add’ action control 1625c may be used to insert an additional alternate query form indicator. The ‘Delete’ action control 1625d may be used to remove an alternate query form. The navigation control 1630 may be used to navigate within content of the activity window 1605.

As illustrated in FIG. 17, a sponsor account GUI 1700 is provided. The GUI 1700 may be presented at any time to a sponsor. The GUI 1700 may include user controls 1502a-e, activity selection indicators 1504a-e, an account information window 1715, account entry indicators 1720a-f, keyword/category indicators 1725a-e, query search window 1750, query search controls 1755a-b, search result indicators 1760a-d, and action controls 1775a-b.

The account information window 1715 may be used to indicate information of a sponsor account. The account entry indicators 1720a-f may be used to provide registration information. The keyword/category indicators 1725a-e may be used to provide information of keywords and/or categories associated with a sponsor. A sponsor might elect to receive a report of queries associated with a keyword or category. Likewise a sponsor might designate that queries associated with a keyword be directed to a guide associated with the sponsor.

The query search window 1750 may be used to search a database of queries. For example, a sponsor might search a database of queries for queries which are not associated with sponsored results. A sponsor might search a database for queries associated with organic results including a keyword. A sponsor might conduct a search to obtain usage information for queries associated with a keyword and/or category. The query search controls 1755a-b may be used to conduct a search. The query search control 1755a may be used to indicate a search query. The query search control 1755b may be used to execute a search based on a query indicated in the query search control 1755a. The search result indicators 1760a-d may be used to provide information of a search result. The search result indicator 1760a indicates the query ‘What is a good hamburger restaurant?’ The search result indicators 1760a-d may be presented in an order based on a ranking of the search results associated with the search result indicators 1760. The ‘Save’ action control 1775a may be used to record information obtained using the GUI 1700. The ‘Cancel’ action control 1775b may be used to discard information obtained using the GUI 1700.

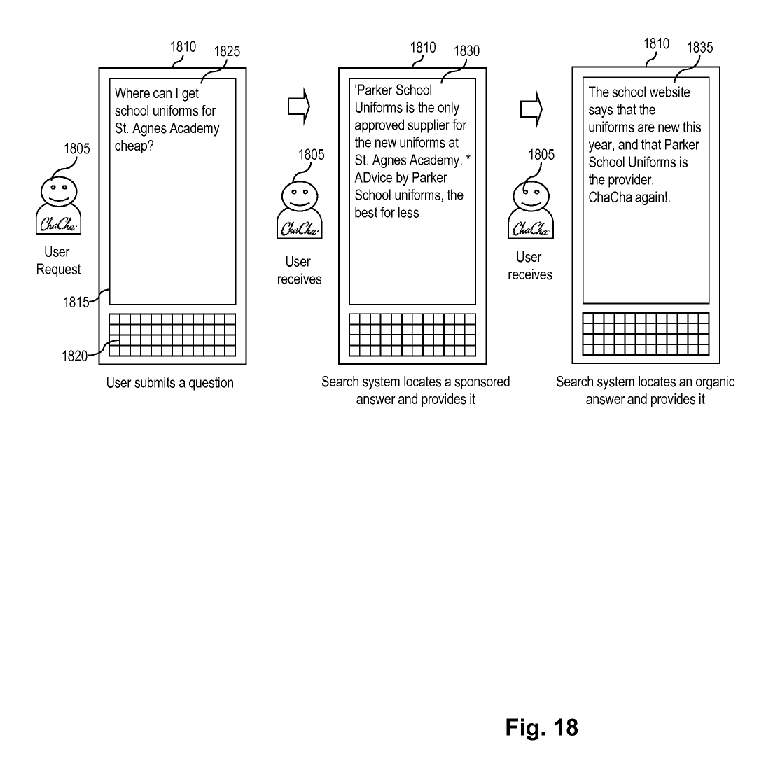

An exemplary sequence of messages associated with a user request is illustrated in FIG. 18. A user 1805 may compose a request message 1825 using a user device 1810. The user device may include a display 1815 and a user input control 1820. The user 1805 may transmit the request message 1825 to a device associated with the search system 130 (FIG. 1). If the search system 130 determines that a sponsored answer is available, the search system 130 may respond with a sponsored answer message 1830. A sponsored answer may be specifically indicated as a sponsored answer. If the search system 130 determines that an organic answer is available, the search system 130 may respond with an organic answer message 1835. In at least one embodiment, if it is determined that the organic answer is equivalent to the sponsored answer, the organic answer may not be provided. Alternately, if a sponsored answer is equivalent to an organic answer, the sponsored answer may be provided, but not identified as a sponsored answer.

While FIG. 18 depicts a text messaging embodiment, not limitation is implied thereby. Any type of media and/or communication may be used to provide a sponsored answer and/or an organic answer in any number.

Using the methods and systems described herein a sponsored answer is created and managed. A sponsored answer may be provided based on a human assisted search, and/or an automated search. A sponsor may register to provide sponsored answers. A sponsor may receive information of a query database which may be used to select queries for which a sponsored answer is to be provided. A sponsor may bid for the opportunity to provide a sponsored answer to a query. A sponsored answer may be provided while maintaining the integrity and credibility of organic results provided.

A rating may be determined for a sponsored answer which may be used to determine whether a sponsored answer is presented responsive to a request. When a query is submitted, a sponsored answer and an organic answer may be obtained responsive to the query. A highest ranking sponsored answer may be provided to a user if the sponsored answer is different from an organic answer provided responsive to a request. A comparison of a sponsored answer to an organic answer may be used to rank the sponsored answer. A source of a sponsored answer may be examined to determine whether the sponsored answer is equivalent to an organic answer.

A human searcher may be associated with a sponsor. If a sponsored answer is not found for a query, a human searcher may be selected to provide a sponsored answer. A human searcher selected to obtain a sponsored answer may be provided with and/or required to obtain a sponsored answer from a resource provided and/or identified by a sponsor. A human searcher may be selected based on a bid by a sponsor associated with a characteristic of the human searcher.

A sponsor may obtain information of queries and responses provided responsive to the queries. A sponsor may define a vocabulary and/or query forms which are associated with the sponsor. If multiple sponsored results are obtained for a query, the sponsored answers may be ranked.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc—Read Only Memory), and a CD-R (Recordable)/RW. An example of communication media includes a carrier-wave signal. Further, according to an aspect of the embodiments, any combinations of the described features, functions and/or operations can be provided.

The many features and advantages of the claimed invention are apparent from the detailed specification and thus, it is intended by the appended claims to cover all such features and advantages of the claimed invention that fall within the true spirit and scope of the invention. Further, since numerous modifications and changes will readily occur to those skilled in the art, it is not desired to limit the invention to the exact construction and operation illustrated and described for the disclosed embodiments, and accordingly all suitable modifications and equivalents may be resorted to, falling within the scope of the claimed invention. It will further be understood that the phrase “at least one of A, B and C” may be used herein as an alternative expression that means “one or more of A, B and C.”

What is claimed is:

1. A method comprising:
receiving a request;
obtaining a response from a pre-determined resource;
acquiring an answer from a highest ranking resource;
comparing, using a processor, the response to the answer;
delivering the response when the response differs from the answer; and
providing the answer.

2. The method of claim 1 further comprising:
delivering the response when a URL associated with the response differs from a URL associated with the answer.

3. The method of claim 1 further comprising:
obtaining the response from a human assistant selected based on the pre-determined resource.

4. The method of claim 1 further comprising:
comparing a portion of content indicated by the response to a segment of content indicated by the answer; and
delivering the response when the portion and the segment are identical.

5. The method of claim 1 further comprising:
acquiring the answer based on a selection of a human assistant of the highest ranking resource.

6. The method of claim 1 further comprising:
selecting the pre-determined resource based on a supplier associated with the pre-determined resource.

7. The method of claim 1 further comprising:
presenting the request to a supplier of the response based on a ranking of the request for a keyword; and

8. The method of claim 1 further comprising:
comparing a portion of content indicated by the response to a segment of content indicated by the answer; and
delivering the response when the portion and the segment are semantically equivalent.

9. The method of claim 1 further comprising:
presenting the request to a supplier of the response based on a rating of a search result obtained from the pre-determined resource for the request.

10. The method of claim 1 further comprising:
presenting the request to a supplier of the response; and
ranking the response based on a selection by a human assistant of responses associated with the request.

11. A system comprising:
a search server device comprising a processor and a memory receiving a request, obtaining a response from a pre-determined resource, acquiring an answer from a highest ranking resource, comparing the response to the answer, and delivering the response when the response differs from the answer; and
a user device receiving the answer.

12. The system of claim 11 further comprising:
a searcher device selecting the response based on a rank of a searcher for a supplier of the response and a ranking of the supplier for the request.

13. A non-transient computer readable storage medium storing therein a program for causing a computer to execute an operation, comprising:
receiving a request;
obtaining a response from a resource associated with a highest ranking supplier;
acquiring an answer from a resource ranked highest for the request;
comparing, using a processor, the response to the answer;
delivering the response when the response differs from the answer; and
providing the answer.

14. The computer readable storage medium of claim 13 wherein the operation further comprises:
ranking the supplier based on ratings of responses associated with the supplier.

15. The computer readable storage medium of claim 13 wherein the operation further comprises:
ranking the resource based on a selection of a human assistant of answers associated with the resource.

16. The computer readable storage medium of claim 13 wherein the operation further comprises:
delivering the response when a human assistant indicates that the response differs from the answer.

17. The computer readable storage medium of claim 13 wherein the operation further comprises:
providing the request, the response and the answer to suppliers; and
obtaining responses from the suppliers.

18. The computer readable storage medium of claim 13 wherein the operation further comprises:
providing the request to a supplier based on a ranking of the request for a keyword; and
associating a result of the supplier with the request and an equivalent request.

19. The computer readable storage medium of claim 13 wherein the operation further comprises:
ranking the request for a keyword based on a number of times the request is received; and
presenting the request to a supplier associated with the keyword in an order based on the ranking.

20. The computer readable storage medium of claim 13 wherein the operation further comprises:
providing the request, the response and the answer to a human assistant when the response differs from the answer by a predetermined criterion; and
modifying the criterion based on a selection of the human assistant.
